(19) United States
(12) Patent Application Publication
(10) Pub. No.: US 2013/0309482 A1
(43) Pub. Date: Nov. 21, 2013

(54) THERMALLY FUNCTIONAL FLAME-RETARDANT POLYMER MEMBER

(71) Applicants: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP)

(72) Inventors: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP)

(73) Assignee: NITTO DENKO CORPORATION, Osaka (JP)

(21) Appl. No.: 13/876,892

(22) PCT Filed: Jun. 16, 2011
(86) PCT No.: PCT/JP2011/063819

§ 371 Date: Mar. 29, 2013

(30) Foreign Application Priority Data
Oct. 8, 2010 (JP) 2010-228226
Oct. 12, 2010 (JP) 2010-229542
Nov. 26, 2010 (JP) 2010-263780

(51) Int. Cl. B32B 27/18

(52) U.S. Cl. CPC B32B 27/18
USPC 428/313.3; 428/688; 428/339

(57) ABSTRACT

Provided is a flame-retardant member having thermal functionality, flexibility, and a high level of flame retardancy. The thermally functional flame-retardant polymer member includes a polymer layer (B), a flame-retardant layer (A), and a thermally functional layer (L) in the stated order, in which the flame-retardant layer (A) includes a layer containing a layered inorganic compound (f) in a polymer.

### TECHNICAL FIELD

The present invention relates to a thermally functional flame-retardant polymer member. The thermally functional flame-retardant polymer member of the present invention is excellent in thermal functionality, transparency, and flexibility, and can impart thermal functionality to various adherends and make the various adherends flame-retardant by being attached to the various adherends.

### BACKGROUND ART

Criteria for combustibility are classified into five stages, i.e., noncombustible, extremely flame-retardant, flame-retardant, slow-burning, and combustible in order of decreasing difficulty in combustion. In a printed matter to be attached to a building material such as an interior material, exterior material, or decorative laminate for a building or housing, or to an interior material or glass portion in a carrier such as a railway vehicle, a ship, or an aircraft, flame retardancy that can be adopted is specified for each of its applications.

A printed matter to be attached to a wall surface in an ordinary shop or the like, a wall surface in a railway vehicle, or a glass portion inside or outside the railway vehicle is as described below. A pattern to be displayed is printed on one surface of a base material sheet such as paper or a film, a pressure-sensitive adhesive layer is provided on the other surface thereof, and the printed matter is attached through the pressure-sensitive adhesive layer. However, such printed matter is combustible and hence most of the printed matter burns out when its combustion is left.

Accordingly, a possible approach to imparting flame retardancy to the base material sheet is to use a flame-retardant resin sheet as the base material sheet. A halogen-based resin such as a fluorine-based resin or a vinyl chloride resin has been conventionally used as such flame-retardant resin sheet (Patent Literature 1). However, the use of a halogen-based flame-retardant sheet has started to be regulated because of such problems of a halogen-containing substance as described below. The substance produces a toxic gas or produces dioxin when burnt. Accordingly, in recent years, the following method has been widely known for imparting flame retardancy to the resin material of a resin sheet (Patent Literature 2). A non-halogen-based flame retardant such as a phosphate or a metal hydrate is added to the resin. In this case, however, a large amount of the flame retardant must be added, with the result that a problem in that the transparency of the resin sheet reduces or a problem such as a defect in the external appearance of the resin sheet is induced.

To laminate, from above the printed matter on which the pattern has been printed, the flame-retardant resin sheet through the pressure-sensitive adhesive layer is also conceivable. In this case, however, a problem in that the clarity of the pattern on the printed matter reduces arises because the resin sheet is laminated on the printed matter through the pressure-sensitive adhesive layer, though flame retardancy is obtained as in the foregoing.

In addition, a material for the flame-retardant resin sheet is a resin. Accordingly, the sheet shows some degree of flame retardancy but does not have such flame retardancy as to be capable of blocking a flame, and hence its flame retardancy when the sheet is in direct contact with the flame is not sufficient.

Further, in recent years, the flame-retardant sheet has been required to have performance such as thermal functionality.

A roof or wall surface of a building or a structure, or the like involves a problem in that the temperature of its surface increases owing to the absorption of solar light energy, which causes a reduction in livability, an increase in cost of air conditioning energy, and the like. Accordingly, when a flame-retardant member having flame retardancy is used in the roof or wall surface of a building or a structure, or the like, such problem as described above needs to be eliminated as well.

In addition, when heat conductivity can be imparted to a flame-retardant member having flame retardancy, the member can be used as, for example, a so-called heat-conductive material such as a heat-dissipating spacer or heat-conductive spacer in the field of semiconductors, or an electrical insulating material.

In addition, depending on a place where the flame-retardant sheet is used, the sheet may be liable to be affected by temperature. In such situation, when heat-insulating property can be imparted to the flame-retardant sheet, the sheet can express, for example, heat-retaining property against a change in external temperature.

### CITATION LIST

### Patent Literature

[PTL 1] Japanese Patent Application Laid-open No. 2005-015620
[PTL 2] Japanese Patent Application Laid-open No. 2001-040172

### SUMMARY OF INVENTION

### Technical Problem

An object of the present invention is to provide a flame-retardant member having thermal functionality, flexibility, and a high level of flame retardancy.

### Solution to Problem

The inventors of the present invention have made extensive studies to solve the problems, and as a result, have found that the problems can be solved with the following flame-retardant polymer member. Thus, the inventors have completed the present invention.

A thermally functional flame-retardant polymer member of the present invention is a thermally functional flame-retardant polymer member, including a polymer layer (B), a flame-retardant layer (A), and a thermally functional layer (L) in the stated order, in which the flame-retardant layer (A) is a layer containing a layered inorganic compound (f) in a polymer.

In a preferred embodiment, the thermally functional layer (L) has a thickness of 0.1 to 200 μm.

In a preferred embodiment, in a horizontal firing test involving horizontally placing the thermally functional flame-retardant polymer member of the present invention with its side of the thermally functional layer (L) as a lower surface so that the lower surface is in contact with air, placing a Bunsen burner so that a flame port of the Bunsen burner is positioned at a lower portion distant from the lower surface on the side of the thermally functional layer (L) by 45 mm, and bringing a flame of the Bunsen burner having a height of 55 mm from the flame port into contact with the lower surface of the thermally functional layer (L) for 30 seconds while preventing the flame from being in contact with an end portion of the flame-retardant polymer member, the flame-retardant polymer member has flame retardancy capable of blocking the flame.

In a preferred embodiment, the thermally functional layer (L) is a heat-shielding layer (L).

Ina preferred embodiment, the heat-shielding layer (L) contains at least one kind selected from a pigment, a ceramic, a metal, and micro balloons.

In a preferred embodiment, the heat-shielding layer (L) is at least one kind selected from an applied layer, a sheet layer, a foil layer, a sputtered layer, and a deposited layer.

In a preferred embodiment, the thermally functional layer (L) is a heat-conductive layer (L).

In a preferred embodiment, the heat-conductive layer (L) contains a heat-conductive substance.

In a preferred embodiment, the heat-conductive substance is at least one kind selected from an inorganic oxide, an inorganic nitride, and a carbon compound.

In a preferred embodiment, the thermally functional layer (L) is a heat-insulating layer (L).

In a preferred embodiment, the heat-insulating layer (L) contains hollow bead structures.

In a preferred embodiment, the hollow bead structures are glass beads.

### Advantageous Effects of Invention

The thermally functional flame-retardant polymer member of the present invention has the polymer layer (B), the flame-retardant layer (A), which is a layer containing the layered inorganic compound (f) in a polymer, and the thermally functional layer (L). As the thermally functional flame-retardant polymer member of the present invention has the thermally functional layer (L), the member can effectively express thermal functionality.

When the thermally functional layer (L) is the heat-shielding layer (L), the thermally functional flame-retardant polymer member of the present invention can express an excellent heat-shielding effect, and for example, when used in a roof or wall surface of a building or a structure, or the like, the member can suppress an increase in surface temperature due to the absorption of solar light energy.

When the thermally functional layer (L) is the heat-conductive layer (L), the thermally functional flame-retardant polymer member of the present invention can express excellent thermal heat conductivity.

When the thermally functional layer (L) is the heat-insulating layer (L), the thermally functional flame-retardant polymer member of the present invention can effectively express excellent heat-insulating performance.

The flame-retardant layer (A) exerts a high level of flame retardancy by virtue of the fact that the layer is a layer containing the layered inorganic compound (f) in the polymer. Despite the fact that the thermally functional flame-retardant polymer member of the present invention has the polymer, the member does not burn and can block a flame for some time even when the member is in direct contact with the flame.

As the flame-retardant layer (A) has the polymer, the member can favorably maintain its flexibility, and has so wide a scope of applications as to be applicable to various applications.

There is no need to incorporate any halogen-based resin into the thermally functional flame-retardant polymer member of the present invention.

In addition, the member is excellent in transparency because the ratio of the layered inorganic compound (f) in the polymer in the flame-retardant layer (A) can be controlled so as to be relatively small. In particular, the member can exert flame retardancy even when the content of ash in the flame-retardant layer (A) is a content as small as less than 70 wt %. As described above, the thermally functional flame-retardant polymer member of the present invention can effectively exert its flame retardancy while satisfying its thermal functionality, flexibility, and transparency.

In addition, the thermally functional flame-retardant polymer member of the present invention is excellent in flame retardancy particularly when the thermally functional flame-retardant polymer member of the present invention is obtained by a production method including the step of laminating a syrupy polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m), followed by the performance of polymerization, and the step of producing the thermally functional layer or when the member is obtained by a production method including the step of laminating a syrupy polymerizable composition layer (a′) formed of a polymerizable composition (α) containing a polymerizable monomer (m1) and the layered inorganic compound (f), and a syrupy polymerizable composition layer (b′) containing a polymerizable monomer (m2) and a polymer (p2), followed by performance of polymerization, and the step of producing the thermally functional layer.

The thermally functional flame-retardant polymer member of the present invention is environmentally advantageous because there is no need to remove a volatile component (such as an organic solvent or an organic Compound) in the polymerizable composition (α) through evaporation upon its production and hence a load on an environment can be reduced.

### BRIEF DESCRIPTION OF DRAWINGS

FIG. 1 is an example of a schematic sectional view of a thermally functional flame-retardant polymer member of the present invention.

FIG. 2 is a schematic view of a method for a horizontal firing test for evaluating the thermally functional flame-retardant polymer member of the present invention for its flame retardancy.

FIG. 3 is an example of a schematic sectional view of the thermally functional flame-retardant polymer member of the present invention and a production method therefor.

FIG. 4 is an example of a schematic sectional view of the thermally functional flame-retardant polymer member of the present invention and the production method therefor.

### DESCRIPTION OF EMBODIMENTS

<<1. Thermally Functional Flame-Retardant Polymer Member>>

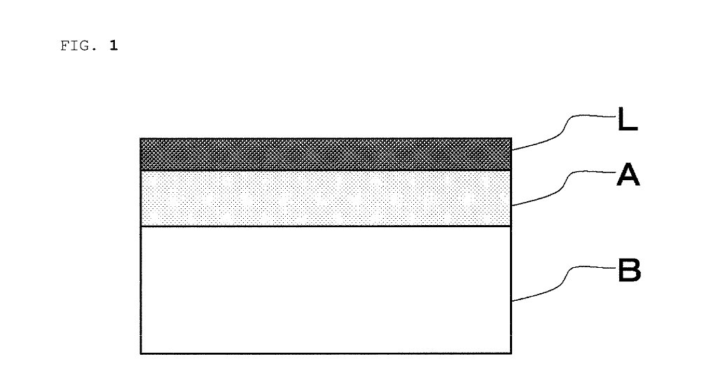

A thermally functional flame-retardant polymer member of the present invention includes a polymer layer (B), a flame-retardant layer (A), and a thermally functional layer (L) in the stated order. The flame-retardant layer (A) is a layer containing a layered inorganic compound (f) in a polymer. FIG. 1 illustrates a schematic view of the thermally functional flame-retardant polymer member of the present invention. Although the flame-retardant layer (A) is provided on one surface of the polymer layer (B) in FIG. 1, the flame-retardant layer (A) can be provided on each of both surfaces of the polymer layer (B). When the flame-retardant layer (A) is provided on each of both surfaces of the polymer layer (B), the thermally functional layer (L) is provided on a surface of at least one of the two polymer layers (B).

### <1-1. Polymer Layer (B)>

The polymer layer (B) contains various polymers at preferably 80 wt % or more, more preferably 90 wt % or more, still more preferably 95 wt % or more, particularly preferably 98 wt % or more, most preferably substantially 100 wt %.

Examples of the polymer in the polymer layer (B) include: an acrylic resin; an urethane-based resin; an olefin-based resin containing an α-olefin as a monomer component such as a polyethylene (PE), a polypropylene (PP), an ethylene-propylene copolymer, or an ethylene-vinyl acetate copolymer (EVA), a polyester-based resin such as a polyethylene terephthalate (PET), a polyethylene naphthalate (PEN), or a polybutylene terephthalate (PBT); a vinyl acetate-based resin; a polyphenylene sulfide (PPS); an amide-based resin such as a polyamide (nylon) or a wholly aromatic polyamide (aramid); a polyimide-based resin; a polyether ether ketone (PEEK); an epoxy resin; an oxetane-based resin; a vinyl ether-based resin; a natural rubber; and a synthetic rubber. The polymer in the polymer layer (B) is preferably an acrylic resin.

The number of kinds of polymers in the polymer layer (B) may be only one, or may be two or more.

The number of kinds of polymerizable monomers that can be used for obtaining the polymer in the polymer layer (B) may be only one, or may be two or more.

Any appropriate polymerizable monomer can be adopted as a polymerizable monomer that can be used for obtaining the polymer in the polymer layer (B).

Examples of the polymerizable monomer that can be used for obtaining the polymer in the polymer layer (B) include a monofunctional monomer, a polyfunctional monomer, a polar group-containing monomer, and any other copolymerizable monomer. Any appropriate content can be adopted as the content of each monomer component such as the monofunctional monomer, the polyfunctional monomer, the polar group-containing monomer, or the other copolymerizable monomer in the polymerizable monomer that can be used for obtaining the polymer in the polymer layer (B) depending on target physical properties of the polymer to be obtained.

Any appropriate monofunctional monomer can be adopted as the monofunctional monomer as long as the monomer is a polymerizable monomer having only one polymerizable group. The number of kinds of the monofunctional monomers may be only one, or may be two or more.

The monofunctional monomer is preferably an acrylic monomer. The acrylic monomer is preferably an alkyl (meth)acrylate having an alkyl group. The number of kinds of the alkyl (meth)acrylates each having an alkyl group may be only one, or may be two or more. It should be noted that the term “(meth)acryl” refers to “acryl” and/or “methacryl.”

Examples of the alkyl (meth)acrylate having an alkyl group include an alkyl (meth)acrylate having a linear or branched alkyl group, and an alkyl (meth)acrylate having a cyclic alkyl group. It should be noted that the alkyl (meth)acrylate as used herein means a monofunctional alkyl (meth)acrylate.

Examples of the alkyl (meth)acrylate having a linear or branched alkyl group include alkyl (meth)acrylates each having an alkyl group having 1 to 20 carbon atoms such as methyl (meth)acrylate, ethyl meth(acrylate), propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Of those, an alkyl (meth)acrylate having an alkyl group having 2 to 14 carbon atoms is preferred, and an alkyl (meth)acrylate having an alkyl group having 2 to 10 carbon atoms is more preferred.

Examples of the alkyl (meth)acrylate having a cyclic alkyl group include cyclopentyl (meth)acrylate, cyclohexyl (meth)acrylate, and isobornyl (meth)acrylate.

Any appropriate polyfunctional monomer can be adopted as the polyfunctional monomer. By adopting the polyfunctional monomer, a cross-linked structure may be given to the polymer in the polymer layer (B). The number of kinds of the polyfunctional monomers may be only one, or may be two or more.

Examples of the polyfunctional monomer include 1,9-nonanediol di(meth)acrylate, 1,6-hexanediol di(meth)acrylate, 1,4-butanediol di(meth)acrylate, (poly)ethylene glycol di(meth)acrylate, (poly)propylene glycol di(meth)acrylate, neopentylglycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, and urethane acrylate. Of those, an acrylate-based polyfunctional monomer is preferred, and 1,9-nonanediol di(meth)acrylate and 1,6-hexanediol di(meth)acrylate are more preferred in terms of having high reactivity and possibly expressing excellent cigarette resistance.

Any appropriate polar group-containing monomer can be adopted as the polar group-containing monomer. The adoption of the polar group-containing monomer can improve the cohesive strength of the polymer in the polymer layer (B), or can increase the adhesive strength of the polymer layer (B). The number of kinds of the polar group-containing monomers may be only one, or may be two or more.

Examples of the polar group-containing monomer include: carboxyl group-containing monomers such as (meth)acrylic acid, itaconic acid, maleic acid, fumaric acid, crotonic acid, and isocrotonic acid, or anhydrides thereof (for example, maleic anhydride); hydroxy group-containing monomers such as a hydroxyalkyl (meth)acrylate such as hydroxyethyl (meth)acrylate, hydroxypropyl (meth)acrylate, or hydroxybutyl (meth)acrylate, vinyl alcohol, and allyl alcohol; amide group-containing monomers such as (meth)acrylamide, N,N-dimethyl (meth)acrylamide, N-methylol (meth)acrylamide, N-methoxymethyl (meth)acrylamide, and N-butoxymethyl (meth)acrylamide; amino group-containing monomers such as aminoethyl (meth)acrylate, dimethylaminoethyl (meth)acrylate, and t-butylaminoethyl (meth)acrylate; glycidyl group-containing monomers such as glycidyl (meth)acrylate and methylglycidyl (meth)acrylate; cyano group-containing monomers such as acrylonitrile and methacrylonitrile; heterocycle-containing vinyl-based monomers such as N-vinyl-2-pyrrolidone and (meth)acryloyl morpholine, as well as N-vinylpyridine, N-vinylpiperidone, N-vinylpyrimidine, N-vinylpiperazine, N-vinylpyrrole, N-vinylimidazole, and N-vinyloxazole; alkoxyalkyl (meth)acrylate-based monomers such as methoxyethyl (meth)acrylate and ethoxyethyl (meth)acrylate; sulfonate group-containing monomers such as sodium vinylsulfonate; phosphate group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate. The polar group-containing monomer is preferably a carboxyl group-containing monomer or an anhydride thereof, more preferably acrylic acid.

Any appropriate other copolymerizable monomer can be adopted as the other copolymerizable monomer. The adoption of the other copolymerizable monomer can improve the cohesive strength of the polymer in the polymer layer (B), or can increase the adhesive strength of the polymer layer (B). The number of kinds of the other copolymerizable monomers may be only one, or may be two or more.

Examples of the other copolymerizable monomer include: an alkyl (meth)acrylate such as a (meth)acrylate having an aromatic hydrocarbon group such as phenyl (meth)acrylate; vinyl esters such as vinyl acetate and vinyl propionate; aromatic vinyl compounds such as styrene and vinyl toluene; olefins and dienes such as ethylene, butadiene, isoprene, and isobutylene; vinyl ethers such as a vinyl alkyl ether; vinyl chloride; alkoxyalkyl (meth)acrylate-based monomers such as methoxyethyl (meth)acrylate and ethoxyethyl (meth)acrylate; sulfonate group-containing monomers such as sodium vinyl sulfonate; phosphate group-containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate; fluorine atom-containing (meth)acrylates; and silicon atom-containing (meth)acrylates.

The polymer layer (B) may contain a flame retardant. Any appropriate flame retardant can be adopted as the flame retardant. Examples of such flame retardant include: organic flame retardants such as a phosphorus-based flame retardant; and inorganic flame retardants such as magnesium hydroxide, aluminum hydroxide, and a layered silicate.

The polymer layer (B) may contain the layered inorganic compound (f) as a flame retardant as in the flame-retardant layer (A). In this case, the ratio at which the layered inorganic compound (f) is filled into the polymer layer (B) is preferably set so as to be lower than the ratio at which the layered inorganic compound (f) is filled into the flame-retardant layer (A). Thus, the flame-retardant layer (A) and the polymer layer (B) are differentiated from each other in terms of degree of flame retardancy.

Any appropriate thickness can be adopted as the thickness of the polymer layer (B). The thickness of the polymer layer (B) is, for example, preferably 1 to 3,000 μm, more preferably 2 to 2,000 μm, still more preferably 5 to 1,000 μm. In addition, the polymer layer (B) may be a single layer, or may be a laminate formed of a plurality of layers.

Pressure-sensitive adhesive property can be imparted to the polymer layer (B) through the selection of a polymer that is a material for forming the layer. For example, an acrylic resin, an epoxy resin, an oxetane-based resin, a vinyl ether-based resin, a urethane-based resin, and a polyester-based resin function as a base polymer for an acrylic pressure-sensitive adhesive, a base polymer for an epoxy-based pressure-sensitive adhesive, a base polymer for an oxetane-based pressure-sensitive adhesive, a base polymer for a vinyl ether-based pressure-sensitive adhesive, a base polymer for a urethane-based pressure-sensitive adhesive, and a base polymer for a polyester-based pressure-sensitive adhesive, respectively.

<1-2. Flame-Retardant Layer (A)>

The same examples as those of the polymer that can be incorporated into the polymer layer (B) can be given as examples of the polymer in the flame-retardant layer (A).

<1-3. Layered Inorganic Compound (f)>

Examples of the layered inorganic compound (f) to be incorporated into the flame-retardant layer (A) include a layered inorganic substance and an organically treated product thereof. The layered inorganic compound (f) may be a solid, or may have flowability. The number of kinds of the layered inorganic compounds may be only one, or may be two or more.

Examples of inorganics which can form a layered inorganic substance include a silicate and a clay mineral. Of those, a layered clay mineral is preferred as the layered inorganic substance.

Examples of the layered clay mineral include: a smectite such as montmorillonite, beidellite, hectorite, saponite, nontronite, or stevensite; vermiculite; bentonite; and a layered sodium silicate such as kanemite, kenyaite, or makatite. Such layered clay mineral may be yielded as a natural mineral, or may be produced by a chemical synthesis method.

The organically treated product of the layered inorganic substance is a product obtained by treating the layered inorganic substance with an organic compound. An example of the organic compound is an organic cationic compound. Examples of the organic cationic compound include cationic surfactants each having a cation group such as a quarternary ammonium salt or a quarternary phosphonium salt. The cationic surfactant has a cationic group such as a quarternary ammonium salt or a quarternary phosphonium salt on a propylene oxide skeleton, an ethylene oxide skeleton, an alkyl skeleton, or the like. Such cationic group preferably forms a quarternary salt with, for example, a halide ion (such as a chloride ion).

Examples of the cationic surfactant which has a quarternary ammonium salt include lauryltrimethylammonium salt, stearyltrimethylammonium salt, trioctylammonium salt, distearyldimethylammonium salt, distearyldibenzylammonium salt, and an ammonium salt having a methyldiethylpropylene oxide skeleton.

Examples of the cationic surfactant which has a quarternary phosphonium salt include dodecyltriphenyl phosphonium salt, methyltriphenylphosphonium salt, lauryltrimethyl phosphonium salt, stearyltrimethyl phosphonium salt, distearyldimethyl phosphonium salt, and distearylbenzyl phosphonium salt.

The layered inorganic substance such as the layered clay mineral is treated with the organic cationic compound. As a result, a cation between layers can undergo ion exchange with a cationic group of a quaternary salt or the like. Examples of the cation of the clay mineral include metal cations such as a sodium ion and a calcium ion. The layered clay mineral treated with the organic cationic compound is easily swollen and dispersed in the polymer or the polymerizable monomer. An example of the layered clay mineral treated with the organic cationic compound is LUCENTITE series (Co-op Chemical Co., Ltd.). As LUCENTITE series (Co-op Chemical Co., Ltd.), more specifically, LUCENTITE SPN, LUCENTITE SAN, LUCENTITE SEN, and LUCENTITE STN are given.

Examples of the organically treated product of the layered inorganic substance include products obtained by subjecting the surface of the layered inorganic substance to surface treatments with various organic compounds (such as a surface tension-lowering treatment with a silicone-based compound or a fluorine-based compound).

The ratio of the organic compound to the layered inorganic substance in the organically treated product of the layered inorganic substance varies depending on the cation-exchange capacity (“CEC”) of the layered inorganic substance. The CEC relates to the ion-exchange capacity of the layered inorganic compound (f) or the total quantity of positive charge that can be caused to adsorb on the surface of the layered inorganic substance, and is represented by positive charge per unit mass of colloid particles, that is, “coulomb(s) per unit mass” in an SI unit. The CEC may be represented by milliequivalent(s) per gram (meq/g) or milliequivalent(s) per 100 grams (meq/100 g). A CEC of 1 meq/g corresponds to 96.5 C/g in the SI unit. Several CEC values concerning representative clay minerals are as described below. The CEC of montmorillonite falls within the range of 70 to 150 meq/100 g, the CEC of halloysite falls within the range of 40 to 50 meg/100 g, and the CEC of kaolin falls within the range of 1 to 10 meq/100 g.

The ratio of the organic compound to the layered inorganic substance in the organically treated product of the layered inorganic substance is such that the amount of the organic compound is preferably 1,000 parts by weight or less, more preferably 3 to 700 parts by weight, more preferably 5 to 500 parts by weight with respect to 100 parts by weight of the layered inorganic substance.

With regard to the particle diameter (average particle diameter) of the layered inorganic compound (f), its particles are preferably packed as densely as possible in a portion in the flame-retardant layer (A) where the layered inorganic compound (f) is distributed from such a viewpoint that good flame retardancy is obtained. For example, the average of primary particle diameters when the layered inorganic compound (f) is dispersed in a dilute solution is preferably 5 nm to 10 μm, more preferably 6 nm to 5 μm, still more preferably 7 nm to 1 μm in terms of a median diameter in a laser scattering method or a dynamic light scattering method. It should be noted that a combination of two or more kinds of particles having different particle diameters may be used as the particles.

The shape of each of the particles may be any shape, e.g., a spherical shape such as a true spherical shape or an ellipsoidal shape, an amorphous shape, a needle-like shape, a rod-like shape, a flat plate-like shape, a flaky shape, or a hollow tubular shape. The shape of each of the particles is preferably a flat plate-like shape or a flaky shape. In addition, the surface of each of the particles may have a pore, a protrusion, or the like.

The average of maximum primary particle diameters is preferably 5 μm or less, more preferably 5 nm to 5 μm because the transparency of the flame-retardant polymer member may be problematic as the particle diameter of the layered clay mineral increases.

It should be noted that the Lucentite SPN (manufactured by Co-op Chemical Co., Ltd.) is obtained by subjecting the layered clay mineral to an organizing treatment with an organic compound having a quaternary ammonium salt, and the ratio of the organic compound is 62 wt %. With regard to its particle diameter, the Lucentite SPN has a 25% average primary particle diameter of 19 nm, a 50% average primary particle diameter of 30 nm, and a 99% average primary particle diameter of 100 nm. The Lucentite SPN has a thickness of 1 nm and an aspect ratio of about 30.

When particles are used as the layered inorganic compound (f), the layered inorganic compound (f) can contribute to, for example, the formation of surface unevenness by the particles in the surface of the flame-retardant layer (A) in some cases.

In addition, when the product obtained by treating the layered clay mineral with the organic cationic compound is used as the layered inorganic compound (f), the Surface resistance value of the flame-retardant layer (A) can be preferably set to 1×10¹⁴ (Q/E) or less, and hence antistatic property can be imparted to the flame-retardant layer (A). The antistatic property can be controlled to desired antistatic property by controlling, for example, the kind, shape, size, and content of the layered inorganic compound (f), and the composition of the polymer component of the flame-retardant layer (A).

As the layered inorganic compound (f) and the polymer are mixed in the flame-retardant layer (A), the layer can exert a characteristic based on the polymer, and at the same time, can exert a characteristic of the layered inorganic compound (f).

The content of ash in the flame-retardant layer (A) (the content of the layered inorganic compound (f) with respect to the total amount of the formation materials for the flame-retardant layer (A), provided that when the layered inorganic compound (f) is an organically treated product of a layered inorganic substance, the content of the layered inorganic substance that has not been subjected to any organic treatment) can be appropriately set depending on the kind of the layered inorganic compound (f). The content is preferably 3 wt % or more and less than 70 wt %. When the content is 70 wt % or more, the layered inorganic compound (f) may not be favorably dispersed. As a result, a lump is apt to be produced and hence it becomes difficult to produce the flame-retardant layer (A) in which the layered inorganic compound (f) has been uniformly dispersed in some cases. When the content is 70 wt % or more, the transparency and flexibility of the flame-retardant polymer member may reduce. On the other hand, when the content is less than 3 wt %, the flame-retardant layer (A) does not have flame retardancy in some cases. The content of the layered inorganic compound (f) in the flame-retardant layer (A) is preferably 3 to 60 wt %, more preferably 5 to 50 wt %.

<1-4. Additive>

Any appropriate additive may be incorporated into the flame-retardant layer (A). Examples of such additive include a surfactant (such as an ionic surfactant, a silicone-based surfactant, or a fluorine-based surfactant), a cross-linking agent (such as a polyisocyanate-based cross-linking agent, a silicone-based cross-linking agent, an epoxy-based cross-linking agent, or an alkyl-etherified melamine-based cross-linking agent), a plasticizer, a filler, an age resister, an antioxidant, a colorant (such as a pigment or a dye), and a solvent (such as an organic solvent).

Any appropriate pigment (coloring pigment) may be incorporated into the flame-retardant layer (A) from the viewpoints of, for example, design and optical characteristics. When a black color is desired, carbon black is preferably used as the coloring pigment. The usage of the pigment (coloring pigment) is, for example, preferably 0.15 part by weight or less, more preferably 0.001 to 0.15 part by weight, still more preferably 0.02 to 0.1 part by weight with respect to 100 parts by weight of the polymer in the flame-retardant layer (A) from such a viewpoint that the degree of coloring and the like are not inhibited.

The flame-retardant layer (A) has a thickness of preferably 3 to 1,000 μm, more preferably 4 to 500 μm, still more preferably 5 to 200 μm. When the thickness of the flame-retardant layer (A) deviates from the range, its flame retardancy may be problematic.

<1-5. Thermally Functional Layer (L)>

Any appropriate layer can be adopted as the thermally functional layer (L) as long as the layer can express thermal functionality. Preferred examples of such thermally functional layer (L) include a heat-shielding layer (L), a heat-conductive layer (L), and a heat-insulating layer (L).

The thickness of the thermally functional layer (L) is preferably 0.1 to 200 μm, more preferably 0.1 to 150 μm, particularly preferably 1 to 100 μm. As long as the thickness of the thermally functional layer (L) falls within the range, the layer can express sufficient thermal functionality without impairing the thermally functional flame-retardant polymer member of the present invention.

(1-5-1. Heat-Shielding Layer (L))

Any appropriate layer can be adopted as the heat-shielding layer (L) as long as the layer can express a heat-shielding effect. The term “heat-shielding effect” specifically refers to the following effect. The generation of thermal energy is suppressed by reflecting a large quantity of infrared rays.

The heat-shielding layer (L) is preferably a layer having an average reflectance for light having any wavelength of from 780 nm to 2,100 nm of 50% or more.

The heat-shielding layer (L) may be formed only of one layer, or may be formed of two or more layers.

The heat-shielding layer (L) preferably contains any appropriate heat-shielding substance. Examples of such heat-shielding substance include a pigment, a ceramic, a metal, and micro balloons. Only one kind of such heat-shielding substances may be used, or two or more kinds thereof may be used in combination.

When the heat-shielding substance is particulate, its average particle diameter is preferably 0.005 to 10 μm, more preferably 0.01 to 1 μm. When the heat-shielding substance is particulate, as long as its average particle diameter falls within the range, the heat-shielding property of the heat-shielding layer (L) can be expressed at a high level.

Any appropriate pigment can be adopted as the pigment. The pigment is, for example, an inorganic pigment. Preferred examples of the inorganic pigment include: a white pigment such as titanium oxide, manganese dioxide, or cobalt oxide; and a pale color pigment using the white pigment and any other pigment in combination

A ceramic of any appropriate form can be adopted as the ceramic.

Any appropriate metal can be adopted as the metal. Examples of the metal include aluminum and copper.

Micro balloons are hollow fine particles each having a cavity in the inside thereof. Examples of the micro balloons include ceramic balloons formed of a glass and a titania composite. Preferred examples thereof include glass beads.

The heat-shielding layer (L) can contain any appropriate additive. Examples of such additive include a plasticizer, a filler, a lubricant, a thermal stabilizer, an anti-fogging agent, a stabilizer, an antioxidant, a surfactant, a resin, and a solvent.

The heat-shielding layer (L) can adopt any appropriate form. The heat-shielding layer (L) is preferably at least one kind selected from an applied layer, a sheet layer, a foil layer, a sputtered layer, and a deposited layer.

When the heat-shielding layer (L) is an applied layer, the heat-shielding layer (L) can be formed by applying any appropriate heat-shielding paint.

When the heat-shielding layer (L) is a sheet layer, the heat-shielding layer (L) is, for example, a sheet layer containing a heat-shielding substance. Such sheet layer can be formed by any appropriate forming method.

When the heat-shielding layer (L) is a foil layer, examples of the heat-shielding layer (L) include foil layers formed of metal foils such as an aluminum foil and a copper foil.

When the heat-shielding layer (L) is a sputtered layer or a deposited layer, the layer can be formed by any appropriate sputtering method or deposition method.

The thickness of the heat-shielding layer (L) is preferably 0.1 to 100 μm, more preferably 1 to 100 μm. As long as the thickness of the heat-shielding layer (L) falls within the range, the layer can express sufficient heat-shielding property without impairing the flame retardancy of the thermally functional flame-retardant polymer member of the present invention.

(1-5-2. Heat-Conductive Layer (L))

Any appropriate layer can be adopted as the heat-conductive layer (L) as long as the layer can express heat conductivity.

The heat-conductive layer (L) may be formed only of one layer, or may be formed of two or more layers.

The heat-conductive layer (L) preferably contains a heat-conductive substance. Any appropriate heat-conductive substance can be adopted as the heat-conductive substance as long as the substance can express heat conductivity. The number of kinds of the heat-conductive substances may be only one, or may be two or more. Examples of the heat-conductive substance include an inorganic oxide, an inorganic nitride, and a carbon compound.

Any appropriate inorganic oxide can be adopted as the inorganic oxide. Examples of the inorganic oxide include metal oxides each containing a metal such as Si, Al, Ti, Zr, Cr, or Fe.

Any appropriate inorganic nitride can be adopted as the inorganic nitride. Examples of the inorganic nitride include boron nitride, aluminum nitride, silicon nitride, and gallium nitride.

Any appropriate carbon compound can be adopted as the carbon compound. Examples of the carbon compound include diamond, graphite, and carbon black.

When the heat-conductive substance is particulate, its average particle diameter is preferably 0.005 to 50 μm, more preferably 0.01 to 10 μm. When the heat-conductive substance is particulate, as long as its average particle diameter falls within the range, the heat conductivity of the heat-conductive layer (L) can be expressed at a high level.

The heat-conductive layer (L) can contain any appropriate additive. Examples of such additive include a plasticizer, a filler, a lubricant, a thermal stabilizer, an anti-fogging agent, a stabilizer, an antioxidant, a surfactant, a resin, and a solvent.

The heat-conductive layer (L) can adopt any appropriate form. Examples of such form include an applied layer and a sheet layer.

When the heat-conductive layer (L) is an applied layer, the heat-conductive layer (L) can be formed by applying any appropriate heat-conductive liquid.

When the heat-conductive layer (L) is a sheet layer, the heat-conductive layer (L) is, for example, a sheet layer containing a heat-conductive substance. Such sheet layer can be formed by any appropriate forming method.

The thickness of the heat-conductive layer (L) is preferably 0.1 to 200 μm, more preferably 0.5 to 100 μm. As long as the thickness of the heat-conductive layer (L) falls within the range, the layer can express sufficient heat conductivity without impairing the flame retardancy of the thermally functional flame-retardant polymer member of the present invention.

(1-5-3. Heat-Insulating Layer (L))

Any appropriate layer can be adopted as the heat-insulating layer (L) as long as a heat-insulating effect is obtained.

The heat-insulating layer (L) preferably contains hollow bead structures. The term “hollow bead structures” refers to structures each including a gas layer in the inside of a bead. Examples of the gas layer include air, nitrogen, and a noble gas. Examples of such hollow bead structures include hollow ceramic beads, hollow silica beads, Shirasu balloons, glass beads, and hollow styrene beads. Of those, the glass beads are particularly preferred.

The heat-insulating layer (L) is more preferably a resin composition containing hollow bead structures. A resin to be incorporated into such resin composition is not particularly limited as long as the resin can retain, for example, a heat-insulating material formed of the hollow beads and can be formed into a predetermined shape. Examples thereof include a polyolefin-based resin, an acrylic resin, a urethane resin, a polyester resin, a polystyrene, a vinyl chloride resin, a vinylidene chloride resin, a vinyl acetate-based resin, a polyamide resin, an epoxy resin, a phenol resin, and a fluorine-based resin.

The heat-insulating layer (L) may further contain any appropriate additive depending on purposes.

Examples of the additive include a photopolymerization initiator, a silane coupling agent, a release agent, a curing agent, a curing accelerator, a diluent, an antioxidant, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the heat-insulating layer (L) can be appropriately set depending on purposes.

The heat-insulating layer (L) may be formed only of one layer, or may be formed of two or more layers.

The thickness of the heat-insulating layer (L) is preferably 0.1 to 100 μm, more preferably 1 to 100 μm. As long as the thickness of the heat-insulating layer (L) falls within the range, the layer can express extremely excellent heat-insulating property without impairing the flame retardancy of the thermally functional flame-retardant polymer member of the present invention.

<1-6. Thermally Functional Flame-Retardant Polymer Member>

The thickness of the entirety of the thermally functional flame-retardant polymer member is preferably 10 to 5,000 μm, more preferably 20 to 4,000 μm, still more preferably 30 to 3,000 μm because of the following reasons. When the thickness is excessively small, the member may not show sufficient flame retardancy. When the thickness is excessively large, the member is hard to wind in a sheet shape and is hence poor in handleability in some cases. It should be noted that the thickness of the entirety of the thermally functional flame-retardant polymer member means the total of the thickness of the flame-retardant layer (A), the thickness of the polymer layer (B), and the thickness of the thermally functional layer (L).

In addition, the ratio of the thickness of the flame-retardant layer (A) to the thickness of the entirety of the thermally functional flame-retardant polymer member (the total of the thickness of the flame-retardant layer (A), the thickness of the polymer layer (B), and the thickness of the thermally functional layer (L)) is preferably 50% or less, more preferably 50 to 0.1%, still more preferably 40 to 1%. When the ratio of the thickness of the flame-retardant layer (A) deviates from the range, its flame retardancy may be problematic or the strength of the flame-retardant layer (A) may be problematic.

<1-7. Flame Retardancy of Thermally Functional Flame-Retardant Polymer Member>

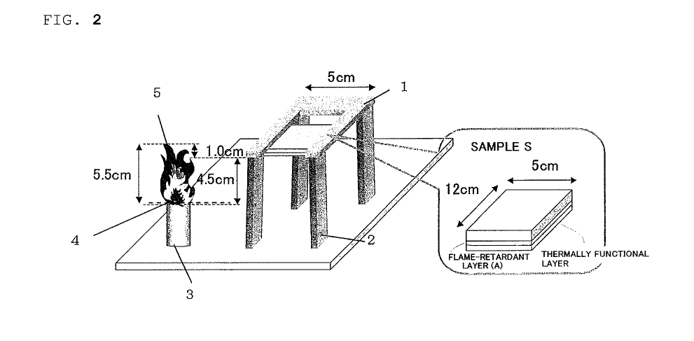

The thermally functional flame-retardant polymer member of the present invention preferably satisfies the following flame retardancy. That is, in a horizontal firing test involving horizontally placing the thermally functional flame-retardant polymer member of the present invention with its side of the thermally functional layer (L) as a lower surface so that the lower surface is in contact with air, placing a Bunsen burner so that the flame port of the Bunsen burner is positioned at a lower portion distant from the lower surface on the side of the thermally functional layer (L) by 45 mm, and bringing the flame of the Bunsen burner having a height of 55 mm from the flame port into contact with the lower surface of the thermally functional layer (L) for 30 seconds, the member has flame retardancy capable of blocking the flame. The horizontal firing test is a test for blocking property against a flame from the side of the thermally functional layer (L) of the oil-repellent flame-retardant polymer member. Therefore, in the horizontal firing test, the flame of the Bunsen burner is brought into contact from the side of the thermally functional layer (L) while being prevented from being in contact with the end portion of the thermally functional flame-retardant polymer member. In ordinary cases, the test is performed by placing the Bunsen burner so that the flame of the Bunsen burner is in contact with a site distant from each of all end portions of the thermally functional flame-retardant polymer member by at least 50 mm or more. Any appropriate size can be adopted as the size of the thermally functional flame-retardant polymer member to be subjected to the horizontal firing test. For example, a rectangle measuring 5 to 20 cm wide by 10 to 20 cm long can be used as the size of the thermally functional flame-retardant polymer member. In FIG. 2 and Examples, a member of a rectangular shape measuring 5 cm by 12 cm is used.

The horizontal firing test is specifically performed as described below. As illustrated in FIG. 2, both sides of a rectangular, thermally functional flame-retardant polymer member S are each horizontally fixed by two upper and lower supporting plates 1 with the side of the thermally functional layer (L) of the rectangle as a lower surface. With regard to the supporting plates 1, both sides in the lengthwise direction of the lower supporting plate 1 are provided with columns 2 so that the lower surface of the thermally functional flame-retardant polymer member S is in contact with air and a Bunsen burner 3 can be placed. In FIG. 2, the rectangular, thermally functional flame-retardant polymer member S measuring 5 cm by 12 cm is used, and each side of the member having a length of 12 cm is fixed by the supporting plates 1 (each having a width of 10 cm). The Bunsen burner 3 is placed so that a distance between its flame port 4 and the lower surface of the thermally functional flame-retardant polymer member S is 45 mm. In addition, the flame port 4 of the Bunsen burner 3 is positioned below the center of the thermally functional flame-retardant polymer member S. The height of the flame of the Bunsen burner 3 from the flame port is adjusted to 55 mm. Although the Bunsen burner 3 is positioned below the flame-retardant polymer member S, the Bunsen burner 3 is illustrated outside the supporting plates 1 in FIG. 2 for convenience.

The test for flame retardancy can evaluate the flame-blocking property of the thermally functional flame-retardant polymer member and the shape-maintaining property of the flame-retardant polymer member when the flame of the Bunsen burner having a size of 1 cm (a difference between the height of the flame from the flame port 4 of the Bunsen burner 3, i.e., 55 mm, and a distance between the lower surface on the side of the thermally functional layer (L) and the flame port 4 of the Bunsen burner 3, i.e., 45 mm) is brought into contact for 30 seconds. A propane gas is used as the gas of the Bunsen burner and the test is performed in the air.

As described in Examples, the thermally functional flame-retardant polymer member can be evaluated for its flame-blocking property by: placing a White Economy 314-048 (manufactured by Biznet) as copy paper at a position 3 mm above the thermally functional flame-retardant polymer member S (above the upper supporting plates 1 on both sides); and observing the presence or absence of the combustion of the copy paper in the horizontal firing test.

### <1-8. Transparency>

The thermally functional flame-retardant polymer member of the present invention is preferably substantially transparent, and has a total light transmittance of preferably 60% or more, more preferably 70% or more, still more preferably 80% or more, particularly preferably 90% or more. Further, its haze is preferably 20% or less, more preferably 10% or less, still more preferably 5% or less.

<1-9. Flexibility>

The thermally functional flame-retardant polymer member of the present invention has flexibility peculiar to plastic. For example, in the case where no flaw or crack occurs even when both ends of a side having a length of 5 cm of the thermally functional flame-retardant polymer member measuring 5 cm by 10 cm are repeatedly brought into contact with each other 50 times by bending the side in a mountain fold manner and in a valley fold manner, the member can be judged to have good flexibility. In addition, in the case where no flaw or crack occurs in the thermally functional flame-retardant polymer member measuring 5 cm by 10 cm when the thermally functional flame-retardant polymer member measuring 5 cm by 10 cm is wound around a rod having a diameter of 1 cm and then the wound flame-retardant polymer member is peeled, the member can be judged to have good flexibility.

<1-10. Heat-Shielding Property>

When the thermally functional layer (L) is the heat-shielding layer (L), the thermally functional flame-retardant polymer member of the present invention has excellent heat-shielding property. For example, as described in Examples, an evaluation for the heat-shielding property can be performed by attaching a temperature sensor to the back surface on the polymer layer (B) side, irradiating the resultant with light from a position 30 cm vertically above its heat-shielding layer (L) side (flame-retardant layer (A) side in the case where the heat-shielding layer (L) is not provided) by using an REF-lamp, and measuring the temperature at the time point when an increase in temperature of the back surface reaches a saturated state. As the thermally functional flame-retardant polymer member of the present invention has excellent heat-shielding property, for example, when used in a roof or wall surface of a building or a structure, or the like, the member can suppress an increase in surface temperature due to the absorption of solar light energy.

<1-11. Heat Conductivity>

When the thermally functional layer (L) is the heat-conductive layer (L), the thermally functional flame-retardant polymer member of the present invention has excellent heat conductivity. For example, an evaluation for the heat conductivity involves exposing a measurement site, measuring a spectral reflectance with a spectrophotometer in conformity with JIS-A-5759, then determining a solar reflectance as a weighted average with a solar spectral distribution, adopting “(100-solar reflectance)” as a solar absorptivity, and using the solar absorptivity as an indicator for the heat conductivity. The heat conductivity of the heat-conductive flame-retardant polymer member of the present invention is preferably 50 to 100%, more preferably 60 to 100%, still more preferably 70 to 100% in terms of a value for the solar absorptivity. In addition, for example, an evaluation for the heat conductivity can also be performed by exposing a measurement site, and measuring a heat conduction coefficient with any appropriate heat conduction coefficient measuring apparatus. The heat conductivity of the thermally functional flame-retardant polymer member of the present invention is preferably 0.5 to 100 W/mK, more preferably 0.7 to 100 W/mK, still more preferably 1 to 100 W/mK in terms of a value for the heat conduction coefficient. As the thermally functional flame-retardant polymer member of the present invention has excellent heat conductivity, the member can be used as, for example, a so-called heat-conductive material such as a heat-dissipating spacer or heat-conductive spacer in the field of semiconductors, or an electrical insulating material.

<1-12. Heat-Insulating Property>

When the thermally functional layer (L) is the heat-insulating layer (L), the thermally functional flame-retardant polymer member of the present invention has excellent heat-insulating property. For example, as described in Examples, an evaluation for the heat-insulating property can be performed by evaluating a degree of dew condensation in the case where the member is exposed to such an environment that dew condensation can occur.

<<2. Production of Thermally Functional Flame-Retardant Polymer Member>>

Any appropriate production method can be adopted as a method of producing thermally functional flame-retardant polymer member of the present invention as long as, for example, a construction including the polymer layer (B), the flame-retardant layer (A), and the thermally functional layer (L) in the stated order is obtained. In the following description, the thermally functional flame-retardant polymer member of the present invention is sometimes referred to as “flame-retardant polymer member of the present invention”.

<2-1. Flame-Retardant Polymer Member Production Method (1)>

A production method (1) is preferably adopted as a method of producing the flame-retardant polymer member of the present invention because good flame retardancy is obtained. In the production method (1), the flame-retardant polymer member of the present invention is produced by a production method including the step of laminating a syrupy polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m), followed by the performance of polymerization, and the step of producing the thermally functional layer (L).

According to the production method (1), the flame-retardant layer (A) and the polymer layer (B) can be obtained by: laminating the polymerizable composition layer (a) formed of the polymerizable composition (α) containing the polymerizable monomer (m) and the layered inorganic compound (f) incompatible with a polymer obtained by polymerizing the polymerizable monomer on at least one surface of the solid monomer-absorbing layer (b) containing the polymer (p) and capable of absorbing the polymerizable monomer (m); and then polymerizing the polymerizable monomer.

In the production method (1), as a result of the lamination, part of the polymerizable monomer (m) in the polymerizable composition layer (a) is absorbed by the monomer-absorbing layer (b), and at the same time, the layered inorganic compound (f) moves in the polymerizable composition layer (a). Accordingly, an unevenly distributed polymerizable composition layer (a1) is obtained, in which the layered inorganic compound (f) is unevenly distributed toward the side opposite to the monomer-absorbing layer (b). Then, the polymerizable monomer (m) in the unevenly distributed polymerizable composition layer (a1) and the polymerizable monomer (m) in the monomer-absorbing layer (b) are polymerized and cured. Thus, the flame-retardant layer (A) and the polymer layer (B) are obtained. An unevenly distributed portion (a21) of the layered inorganic compound (f) in an unevenly distributed polymer layer (a2) obtained by curing the unevenly distributed polymerizable composition layer (a1) corresponds to the flame-retardant layer (A). A non-unevenly distributed portion (a22) of the layered inorganic compound (f) in the unevenly distributed polymer layer (a2) and a cured monomer-absorbing layer (b2) formed by polymerizing a monomer-absorbing layer (b1) obtained by the absorption of the polymerizable monomer (m) by the monomer-absorbing layer (b) correspond to the polymer layer (B). In other words, a portion obtained by combining the non-unevenly distributed portion (a22) and the cured monomer-absorbing layer (b2) corresponds to the polymer layer (B).

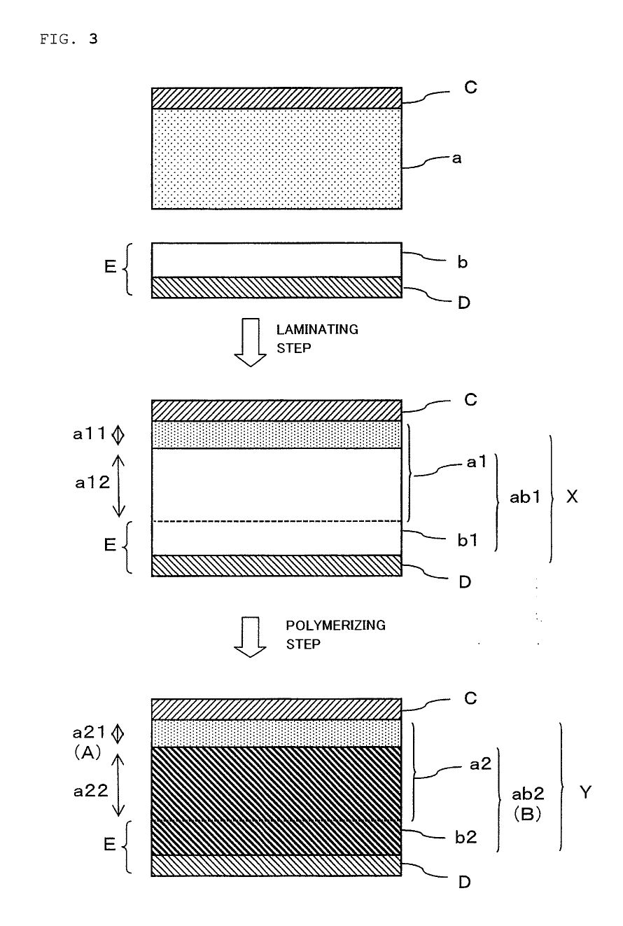

Hereinafter, the “step of laminating the syrupy polymerizable composition layer (a) formed of the polymerizable composition (α) containing the polymerizable monomer (m) and the layered inorganic compound (f), and the solid monomer-absorbing layer (b) containing the polymer (p) and capable of absorbing the polymerizable monomer (m), followed by the performance of polymerization” in the flame-retardant polymer member production method (1) is described with reference to FIG. 3.

First, in a laminating step (1), a laminate (X) is obtained by laminating the polymerizable composition layer (a) and the monomer-absorbing layer (b). The polymerizable composition layer (a) contains the layered inorganic compound (f) and the polymerizable monomer (m) (not shown). Although the polymerizable composition layer (a) can be laminated on at least one surface of the monomer-absorbing layer (b), FIG. 3 illustrates the case where the layer is laminated only on one surface of the monomer-absorbing layer (b). In FIG. 3, a cover film (C) is provided on the side of the polymerizable composition layer (a) not laminated on the monomer-absorbing layer (b). In addition, in FIG. 3, the monomer-absorbing layer (b) is provided on a base material film (D) and then the entirety is used as a monomer-absorbable sheet (E) with a base material.

In the laminate (X) obtained by the laminating step (1), part of the polymerizable monomer (m) in the polymerizable composition layer (a) is absorbed by the monomer-absorbing layer (b) (not shown). Meanwhile, in the polymerizable composition layer (a), the layered inorganic compound (f) moves, and the layered inorganic compound (f) is unevenly distributed toward the side opposite to the monomer-absorbing layer (b). Thus, the unevenly distributed polymerizable composition layer (a1) having an unevenly distributed portion (a11) and a non-unevenly distributed portion (a12) of the layered inorganic compound (f) is obtained. That is, as a result of the lamination of the polymerizable composition layer (a) and the monomer-absorbing layer (b), the polymerizable monomer (m) in the polymerizable composition layer (a) is absorbed by the monomer-absorbing layer (b), and the layered inorganic compound (f) is unevenly distributed toward the side opposite to the monomer-absorbing layer (b). Thus, the unevenly distributed polymerizable composition layer (a1) is obtained.

The phenomenon of the uneven distribution of the layered inorganic compound (f) in the unevenly distributed polymerizable composition layer (a1) is assumed to be caused by the swelling of the monomer-absorbing layer (b). That is, the monomer-absorbing layer (b) absorbs the polymerizable monomer (m) to swell. Meanwhile, the layered inorganic compound (f) is free of being absorbed by the monomer-absorbing layer (b). Accordingly, the layered inorganic compound (f) may be unevenly distributed in such a manner as to remain in the polymerizable composition layer (a). Therefore, when a base material that does not absorb the polymerizable monomer (m) is used as the monomer-absorbing layer (b), the base material does not swell with respect to the polymerizable monomer (m). Accordingly, even when the polymerizable composition layer (a) is laminated on the base material, the layered inorganic compound (f) is not unevenly distributed and hence the unevenly distributed polymerizable composition layer (a1) is not obtained.

In the flame-retardant polymer member production method (1), the laminate (X) can be subjected to a heating step. The unevenly distributed polymerizable composition layer (a1) including the unevenly distributed portion (a11) in which the layered inorganic compound (f) is unevenly distributed at a high density is obtained by the heating step. A heating temperature and a heating time for the laminate (X) are controlled in the heating step. When such heating step is performed, the monomer-absorbing layer (b) of the laminate (X) absorbs a larger amount of the polymerizable monomer (m) in the polymerizable composition layer (a) than that in the case where the laminating step (1) is merely performed, and hence high-density uneven distribution of the layered inorganic compound (f) becomes significant. As described above, the unevenly distributed portion (a11) in which the layered inorganic compound (f) is unevenly distributed at a high density is obtained by the heating step. Accordingly, even when the unevenly distributed polymerizable composition layer (a1) and the unevenly distributed polymer layer (a2) are thin layers, the layered inorganic compound (f) can be unevenly distributed with efficiency and hence a laminate (Y) having the thin-layered unevenly distributed polymer layer (a2) can be obtained.

The polymerizable monomer (m) in the polymerizable composition layer (a) is subjected to a polymerizing step (2) after part thereof has been absorbed by the monomer-absorbing layer (b). Accordingly, adhesiveness between the unevenly distributed polymer layer (a2) and the cured monomer-absorbing layer (b2) is excellent in the laminated structure of the unevenly distributed polymer layer (a2) and the cured monomer-absorbing layer (b2).

The monomer-absorbing layer (b1) in the laminate (X) is in a swollen state as a result of the absorption of the polymerizable monomer (m) by the monomer-absorbing layer (b). Accordingly, an interface between the non-unevenly distributed portion (a12) of the layered inorganic compound (f) in the unevenly distributed polymerizable composition layer (a1) and the monomer-absorbing layer (b1) cannot be observed (a composite site of these layers is represented as abl in FIG. 3). In FIG. 3, the interface is indicated by a broken line for convenience.

Next, the polymerizable monomer (m) in the unevenly distributed polymerizable composition layer (a1) is polymerized by subjecting the laminate (X) to a polymerizing step (2). Thus, the laminate (Y) including the unevenly distributed polymer layer (a2) is obtained. The unevenly distributed polymer layer (a2) is obtained by curing the unevenly distributed polymerizable composition layer (a1) while maintaining the unevenly distributed structure in the layer. The unevenly distributed polymer layer (a2) has the unevenly distributed portion (a21) of the layered inorganic compound (f) and the non-unevenly distributed portion (a22) of the layered inorganic compound (f).

The monomer-absorbing layer (b1) is turned into the cured monomer-absorbing layer (b2) by the polymerizing step (2). Although an interface between the non-unevenly distributed portion (a22) of the layered inorganic compound (f) in the unevenly distributed polymer layer (a2) and the cured monomer-absorbing layer (b2) cannot be observed in the laminate (Y) (a composite site of these layers is represented as ab2 in FIG. 3), the interface is indicated by a broken line in FIG. 3 for convenience.

The production method (1) includes the step of producing the thermally functional layer (L). The step of producing the thermally functional layer (L) (thermally functional layer (L)-producing step (3)) can be performed at any appropriate timing in the production method (1).

(2-1-1. Laminating Step (1))

In the laminating step (1), a laminate having a structure “polymerizable composition layer (a)/monomer-absorbing layer (b)” is produced by laminating the polymerizable composition layer (a) on at least one surface of the monomer-absorbing layer (b). The polymerizable composition layer (a) is a layer formed of the polymerizable composition (α).

(2-1-1-1. Polymerizable Composition (α))

The polymerizable composition (α) contains at least the polymerizable monomer (m) and the layered inorganic compound (f).

The polymerizable composition (α) may be a partially polymerized composition obtained by polymerizing part of the polymerizable monomer (m) in terms of, for example, handleability and application property.

The description of the polymerizable monomer in the section <1-1. Polymer layer (B)> can be cited as specific description of the polymerizable monomer (m).

When the flame-retardant polymer member is used in an application where pressure-sensitive adhesive property is demanded of the unevenly distributed polymer layer (a2), the content of an alkyl (meth)acrylate is preferably 70 wt % or more, more preferably 80 wt % or more with respect to the total amount of the polymerizable monomer (m).

When an oil-repellent flame-retardant polymer member is used in an application where hard physical property is demanded of the unevenly distributed polymer layer (a2) (e.g., a film application), the content of an alkyl (meth)acrylate is preferably 95 wt % or less, more preferably 0.01 to 95 wt %, still more preferably 1 to 70 wt % with respect to the total amount of the polymerizable monomer (m).

When the flame-retardant polymer member is used in an application where pressure-sensitive adhesive property is demanded of the unevenly distributed polymer layer (a2), the content of a polyfunctional monomer is preferably 2 wt % or less, more preferably 0.01 to 2 wt %, still more preferably 0.02 to 1 wt % with respect to the total amount of the polymerizable monomer (m). When the content of the polyfunctional monomer exceeds 2 wt % with respect to the total amount of the polymerizable monomer (m), there may arise a problem in that the cohesive strength of a flame-retardant polymer member to be obtained becomes excessively high and the member becomes excessively brittle. In addition, when the content of the polyfunctional monomer is less than 0.01 wt % with respect to the total amount of the polymerizable monomer (m), the purpose of the use of the polyfunctional monomer may not be achieved.

When the flame-retardant polymer member is used in an application where hard physical property is demanded of the unevenly distributed polymer layer (a2), the content of a polyfunctional monomer is preferably 95 wt % or less, more preferably 0.01 to 95 wt %, still more preferably 1 to 70 wt % with respect to the total amount of the polymerizable monomer (m). When the content of the polyfunctional monomer exceeds 95 wt % with respect to the total amount of the polymerizable monomer (m), curing shrinkage at the time of polymerization increases. Accordingly, it may become impossible to obtain a flame-retardant polymer member having a uniform film shape or sheet shape, or a flame-retardant polymer member to be obtained may become excessively brittle. In addition, when the content of the polyfunctional monomer is less, than 0.01 wt % with respect to the total amount of the polymerizable monomer (m), it may become impossible to obtain a flame-retardant polymer member having sufficient solvent resistance and heat resistance.

When the flame-retardant polymer member is used in an application where pressure-sensitive adhesive property is demanded of the unevenly distributed polymer layer (a2), the content of a polar group-containing monomer is preferably 30 wt % or less, more preferably 1 to 30 wt %, still more preferably 2 to 20 wt % with respect to the total amount of the polymerizable monomer (m). When the content of the polar group-containing monomer exceeds 30 wt % with respect to the total amount of the polymerizable monomer (m), the cohesive strength of a polymer to be obtained may become excessively high, for example, the unevenly distributed polymer layer (a2) may become excessively hard, and the adhesiveness may reduce. In addition, when the content of the polar group-containing monomer is less than 1 wt % with respect to the total amount of the polymerizable monomer (m), the cohesive strength of a polymer to be obtained may reduce and a high shearing force may not be obtained.

When the flame-retardant polymer member is used in an application where hard physical property is demanded of the unevenly distributed polymer layer (a2), the content of a polar group-containing monomer is preferably 95 wt % or less, more preferably 0.01 to 95 wt %, still more preferably 1 to 70 wt % with respect to the total amount of the polymerizable monomer (m). When the content of the polar group-containing monomer exceeds 95 wt % with respect to the total amount of the polymerizable monomer (m), for example, thermal functionality may become insufficient, which increases a change in quality of the flame-retardant polymer member due to a use environment (such as humidity or moisture). In addition, when the content of the polar group-containing monomer is 0.01 wt % or less with respect to the total amount of the polymerizable monomer (m), the addition amount of a (meth)acrylate having a high glass transition temperature (Tg) (such as isobornyl acrylate), a polyfunctional monomer, or the like is increased in the case of obtaining hard physical property, and a flame-retardant polymer member to be obtained may become excessively brittle.

The description in the section <1-3. Layered inorganic compound (f)> can be cited as specific description of the layered inorganic compound (f).

The polymerizable composition (α) may contain any appropriate additive. The description in the section <1-4. Additive> can be cited as specific description of such additive.

The polymerizable composition (α) can contain any appropriate polymerization initiator. Examples of the polymerization initiator include a photopolymerization initiator and a thermal polymerization initiator. The number of kinds of the polymerization initiators may be only one, or may be two or more.

As the photopolymerization initiator, any appropriate photopolymerization initiator may be adopted. Examples of the photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, and a thioxanthone-based photopolymerization initiator. The number of kinds of the photopolymerization initiators may be only one, or may be two or more.

An example of the ketal-based photopolymerization initiator is 2,2-dimethoxy-1,2-diphenylethan-1-one (such as “Irgacure 651” (trade name; manufactured by Ciba Speciality Chemicals Inc.)). Examples of the acetophenone-based photopolymerization initiator include 1-hydroxycyclohexyl phenyl ketone (such as “Irgacure 184” (trade name; manufactured by Ciba Speciality Chemicals Inc.)), 2,2-diethoxyacetophenone, 2,2-dimethoxy-2-phenylacetophenone, 4-phenoxydichloroacetophenone, and 4-(t-butyl)dichloroacetophenone. Examples of the benzoin ether-based photopolymerization initiator include benzoin methyl ether, benzoin ethyl ether, benzoin propyl ether, benzoin isopropyl ether, and benzoin isobutyl ether. An example of the acylphosphine oxide-based photopolymerization initiator is “Lucirin TPO” (trade name; manufactured by BASF Japan Ltd.). Examples of the α-ketol-based photopolymerization initiator include 2-methyl-2-hydroxy propiophenone and 1-[4-(2-hydroxyethyl)phenyl]-2-methylpropan-1-one. An example of the aromatic sulfonyl chloride-based photopolymerization initiator is 2-naphthalenesulfonyl chloride. An example of the photoactive oxime-based photopolymerization initiator is 1-phenyl-1,1-propanedione-2-(o-ethoxycarbonyl)-oxime. An example of the benzoin-based photopolymerization initiator is benzoin. An example of the benzyl-based photopolymerization initiator is benzyl. Examples of the benzophenone-based photopolymerization initiator include benzophenone, benzoylbenzoic acid, 3,3′-dimethyl-4-methoxybenzophenone, polyvinyl benzophenone, and α-hydroxycyclohexyl phenyl ketone. Examples of the thioxanthone-based photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The usage of the photopolymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

Examples of the thermal polymerization initiator include an azo-based polymerization initiator (such as 2,2′-azobisisobutyronitrile, 2,2′-azobis-2-methylbutyronitrile, 2,2′-azobis(2-methylpropionate)dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine) disulfate, or 2,2′-azobis(N,N′-dimethyleneisobutylamidine)dihydrochloride), a peroxide-based polymerization initiator (such as dibenzoyl peroxide or tert-butyl permaleate), and a redox-based polymerization initiator (such as a combination of: an organic peroxide and a vanadium compound; an organic peroxide and dimethylaniline; or a metal naphthenate and butylaldehyde, aniline, or acetylbutyrolactone).

The usage of the thermal polymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

The use of a redox-based polymerization initiator as the thermal polymerization initiator enables the polymerization of the composition at normal temperature.

Whether or not a substance is a substance incompatible with a polymer can be judged by means of visual observation, an optical microscope, a scanning electron microscope (SEM), a transmission electron microscope (TEM), X-ray diffraction, or the like on the basis of the size of the substance or an aggregate thereof dispersed in the polymer in a general method (such as: a method involving dissolving the substance in a polymerizable monomer, polymerizing the polymerizable monomer to provide a polymer, and performing the judgment; a method involving dissolving the polymer in a solvent that dissolves the polymer, adding the substance to the solution, stirring the mixture, removing the solvent after the stirring, and performing the judgment; or a method involving heating the polymer, when the polymer is a thermoplastic polymer, to dissolve the polymer, compounding the substance into the dissolved polymer, cooling the mixture, and performing the judgment after the cooling). Criteria for the judgment are as described below. When the substance or the aggregate thereof can be approximated as a spherical shape such as a sphere, a cube, or an amorphous shape, the substance or the aggregate thereof should have a diameter of 5 nm or more. In addition, when the substance or the aggregate thereof can be approximated as a cylindrical shape such as a rod-like shape, a thin-layer shape, or a rectangular parallelepiped shape, the length of its longest side should be 10 nm or more.

Upon dispersion of the substance in the polymer, when the substance or the aggregate thereof in the polymer can be approximated as a spherical shape such as a sphere, a cube, or an amorphous shape, and the substance or the aggregate thereof which is of a spherical shape has a diameter of 5 nm or more, the substance can be regarded as being incompatible with the polymer. In addition, when the substance or the aggregate thereof in the polymer can be approximated as a cylindrical shape such as a rod-like shape, a thin-layer shape, or a rectangular parallelepiped shape, and the length of the longest side of the substance or the aggregate thereof which is of a cylindrical shape is 10 nm or more, the substance can be regarded as being incompatible with the polymer.

A method of dispersing the layered inorganic compound (f) in the polymerizable composition (α) is, for example, a method involving mixing the polymerizable monomer (m), the layered inorganic compound (f), and as required, any other component (such as a polymerization initiator), and uniformly dispersing the contents by means of ultrasonic dispersion or the like.

The content of the layered inorganic compound (f) in the polymerizable composition (α) is preferably 1 to 300 parts by weight, more preferably 3 to 200 parts by weight, still more preferably 5 to 100 parts by weight with respect to 100 parts by weight of the polymerizable monomer (m). When the content of the layered inorganic compound (f) exceeds 300 parts by weight with respect to 100 parts by weight of the polymerizable monomer (m), it may become difficult to produce the flame-retardant polymer member or a problem in that the strength of the flame-retardant polymer member after the production reduces may arise. When the content of the layered inorganic compound (f) is less than 1 part by weight with respect to 100 parts by weight of the polymerizable monomer (m), it may become hard to obtain the unevenly distributed polymerizable composition layer (a1) or the unevenly distributed polymer layer (a2) after the laminate has been obtained in the laminating step (1), or the unevenly distributed polymer layer (a2) may not have any flame retardancy.

Any appropriate content can be adopted as the content of the layered inorganic compound (f) in the polymerizable composition (α) depending on, for example, the kind of the layered inorganic compound (f). For example, when particles are used as the layered inorganic compound (f), the content of the layered inorganic compound (f) is preferably 0.001 to 70 parts by weight, more preferably 0.01 to 60 parts by weight, still more preferably 0.1 to 50 parts by weight with respect to 100 parts by weight of the polymerizable monomer (m). When the content of the layered inorganic compound (f) as particles is less than 0.001 part by weight with respect to the polymerizable monomer (m), it may become difficult to provide the entirety of the surface to be utilized of a surface uneven sheet with an uneven structure in an average manner. When the content of the layered inorganic compound (f) as particles exceeds 70 parts by weight with respect to the polymerizable monomer (m), the particles may drop during the production of the surface uneven sheet or a problem in that the strength of the surface uneven sheet reduces may arise.

The polymerizable composition (α) is preferably provided with a moderate viscosity suitable for an application operation because the composition is typically formed into a sheet shape by, for example, being applied onto a base material. The viscosity of the polymerizable composition (α) can be adjusted by, for example, compounding any one of the various polymers such as an acrylic rubber and a thickening additive, or polymerizing part of the polymerizable monomer (m) in the polymerizable composition (α) through photoirradiation, heating, or the like. It should be noted that a desired viscosity is as described below. A viscosity set with a BH viscometer under the conditions of a rotor of a No. 5 rotor, a rotational frequency of 10 rpm, and a measurement temperature of 30° C. is preferably 5 to 50 Pa·s, more preferably 10 to 40 Pa·s. When the viscosity is less than 5 Pa·s, the liquid may flow when applied onto the base material. When the viscosity exceeds 50 Pa·s, the viscosity is so high that it may become difficult to apply the liquid.

(2-1-1-2. Polymerizable Composition Layer (a))

The polymerizable composition layer (a) is a layer formed of the polymerizable composition (α).

The polymerizable composition layer (a) is obtained by, for example, applying the polymerizable composition (α) onto abase material such as a PET film to form the composition into a sheet shape.

For the application of the polymerizable composition (α), any appropriate coater may be used, for example. Examples of such coater include a comma roll coater, a die roll coater, a gravure roll coater, a reverse roll coater, a kiss roll coater, a dip roll coater, a bar coater, a knife coater, and a spray coater.

The thickness of the polymerizable composition layer (a) is, for example, preferably 3 to 3,000 μm, more preferably 10 to 1,000 μm, still more preferably 20 to 500 μm. When the thickness of the polymerizable composition layer (a) is less than 3 μm, it may be unable to perform uniform application or the unevenly distributed polymer layer (a2) may not have any flame retardancy. On the other hand, when the thickness of the polymerizable composition layer (a) exceeds 3,000 μm, there is a possibility that waviness occurs in the flame-retardant polymer member and hence a smooth oil-repellent flame-retardant polymer member is not obtained.

(2-1-1-3. Monomer-Absorbing Layer (b))

The monomer-absorbing layer (b) is a layer capable of absorbing part of the polymerizable monomer (m) from the polymerizable composition layer (a). It is preferred that the monomer-absorbing layer (b) have a high affinity for the polymerizable monomer (m) and be capable of absorbing the polymerizable monomer (m) at a high rate. It should be noted that a surface provided by the monomer-absorbing layer (b) is referred to as “monomer-absorbing surface.”

The absorption of the polymerizable monomer (m) in the monomer-absorbing layer (b) occurs at the time point when a laminate having a structure “polymerizable composition layer (a)/monomer-absorbing layer (b)” is formed by the laminating step (1). The absorption of the polymerizable monomer (m) in the monomer-absorbing layer (b) occurs more effectively when the heating step is performed. It should be noted that the time point when the absorption of the polymerizable monomer (in) in the monomer-absorbing layer (b) occurs is not limited to any stage prior to the polymerizing step (2) and the absorption may occur at the stage of the polymerizing step (2).

The monomer-absorbing layer (b) can be such a sheet-shaped structure that the monomer-absorbing surface of the monomer-absorbing layer (b) can be in contact with the polymerizable composition layer (a) (hereinafter, referred to as “monomer-absorbable sheet”).

Examples of the monomer-absorbable sheet include a monomer-absorbable sheet constituted only of the monomer-absorbing layer (b) (hereinafter, referred to as “base material-less monomer-absorbable sheet”) and a monomer-absorbable sheet obtained by providing the monomer-absorbing layer (b) on a base material (hereinafter, referred to as “monomer-absorbable sheet with a base material”). It should be noted that when the monomer-absorbable sheet is a base material-less monomer-absorbable sheet, each surface of the sheet may be used as a monomer-absorbing surface. In addition, when the monomer-absorbable sheet is a monomer-absorbable sheet with a base material, the surface on the side of the monomer-absorbing layer (b) serves as a monomer-absorbing surface.

The monomer-absorbing layer (b) contains the polymer (p). The content of the polymer (p) in the monomer-absorbing layer (b) is preferably 80 wt % or more, more preferably 90 wt % or more, still more preferably 95 wt % or more, particularly preferably 98 wt % or more, most preferably substantially 100 wt %. The number of kinds of the polymers (p) in the monomer-absorbing layer (b) may be only one, or may be two or more.

The description of the polymerizable monomer in the section <1-1. Polymer layer (B)> can be cited as specific description of a monomer component to be used for obtaining the polymer (p).

At least one of the monomer components to be used for obtaining the polymer (p) is preferably common to at least one of the polymerizable monomers (m) in the polymerizable composition (α).

The polymer (p) is preferably an acrylic resin obtained by polymerizing a monomer component containing an acrylic monomer.

The polymer (p) can be obtained by any appropriate polymerization method as long as the monomer component to be used for obtaining the polymer (p) can be polymerized by the method. The description of a polymerization method in a section (2-1-3. Polymerizing step (2)) to be described later can be cited as specific description of a preferred polymerization method.

The polymer (p) may be a polymer obtained by polymerizing a polymerizable composition having the same composition as that of the polymerizable composition (α) except that the layered inorganic compound (f) is removed from the polymerizable composition (α).

The monomer-absorbing layer (b) may contain any appropriate additive. The description in the section <1-4. Additive> can be cited as specific description of such additive.

The monomer-absorbing layer (b) may contain a flame retardant as in the polymer layer (B).

The monomer-absorbing layer (b1) in the laminate (X) preferably shows a weight 1.1 or more times as large as the weight of the monomer-absorbing layer (b) to be used in the laminating step (1) as a result of the absorption of the polymerizable monomer (m) in the polymerizable composition layer (a) by the monomer-absorbing layer (b). When the weight increase ratio as a result of the absorption of the polymerizable monomer (m) by the monomer-absorbing layer (b) becomes 1.1 or more, the layered inorganic compound (f) can be unevenly distributed in an effective manner. The weight increase ratio is more preferably 2 or more, still more preferably 3 or more, particularly preferably 4 or more. The weight increase ratio is preferably 50 or less in terms of the maintenance of the smoothness of the monomer-absorbing layer (b).

The weight increase ratio can be calculated as described below. After a lapse of the same time period as the time period from the immersion of the monomer-absorbing layer (b) in the polymerizable monomer (m) through the lamination of the polymerizable composition layer (a) on the monomer-absorbing layer (b) to the performance of the polymerizing step (2), and at the same temperature as the temperature at which the foregoing process is performed, the weight of the monomer-absorbing layer (b) is measured and then the ratio is calculated as a ratio of the weight after the absorption of the polymerizable monomer (m) to the weight before the absorption of the polymerizable monomer (m).

The volume of the monomer-absorbing layer (b) after the absorption of the polymerizable monomer (m) may be constant as compared with that before the absorption, or may change as compared with that before the absorption.

Any appropriate value can be adopted as the gel fraction of the monomer-absorbing layer (b). The flame-retardant polymer member of the present invention can be obtained irrespective of whether cross-linking has progressed to attain a gel fraction of about 98 wt % in the monomer-absorbing layer (b) or nearly no cross-linking has occurred in the layer (e.g., the gel fraction is 10 wt % or less).

Sufficient heat resistance and sufficient solvent resistance can be imparted to the polymer layer (B) in the flame-retardant polymer member to be obtained by providing the monomer-absorbing layer (b) with a high degree of cross-linking (such as a gel fraction of 90 wt % or more). Sufficient flexibility and sufficient stress-relaxing property can be imparted to the polymer layer (B) in the flame-retardant polymer member to be obtained by providing the monomer-absorbing layer (b) with a low degree of cross-linking (such as a gel fraction of 10 wt % or less).

The gel fraction can be calculated from, for example, a weight change amount when a measuring object is wrapped with a TEMISH (manufactured by, for example, Nitto Denko Corporation) as a mesh made of tetrafluoroethylene, the wrapped product is immersed in ethyl acetate for 1 week, and then the measuring object is dried.

The flame-retardant polymer member of the present invention can be obtained irrespective of whether the monomer-absorbing layer (b) is a hard layer or a soft layer. When a hard layer (such as a layer having a 100% modulus of 100 N/cm² or more) is used as the monomer-absorbing layer (b), the monomer-absorbing layer (b) can be used as a support (base material) When a soft layer (such as a layer having a 1.00% modulus of 30 N/cm² or less) is used as the monomer-absorbing layer (b), the monomer-absorbing layer (b) can be used as a pressure-sensitive adhesive layer.

Any appropriate thickness can be adopted as the thickness of the monomer-absorbing layer (b) before the absorption of the polymerizable monomer (m). The thickness of the monomer-absorbing layer (b) before the absorption of the polymerizable monomer (m) is, for example, preferably 1 to 3,000 μm, more preferably 2 to 2,000 μm, still more preferably 5 to 1,000 μm. When the thickness of the monomer-absorbing layer (b) before the absorption of the polymerizable monomer (m) is less than 1 μm, the monomer-absorbing layer (b) may deform in the case where the layer has absorbed a large amount of the polymerizable monomer (m), or the absorption of the polymerizable monomer (m) may not be sufficiently performed. When the thickness of the monomer-absorbing layer (b) before the absorption of the polymerizable monomer (m) exceeds 3,000 μm, there is a possibility that the flame-retardant polymer member to be finally obtained is hard to wind in a sheet shape and is hence poor in handleability.

The monomer-absorbing layer (b) may be a single layer, or may be a laminate of two or more layers.

The monomer-absorbing layer (b) can be produced by applying a composition as a material for forming the monomer-absorbing layer (b) (hereinafter, referred to as “monomer-absorbing layer (b)-forming composition”) onto a predetermined surface of any appropriate support such as a release-treated surface of a base material or cover film to be described later with any appropriate coater or the like. The monomer-absorbing layer (b)-forming composition applied onto the support is subjected to drying and/or curing (such as curing with light) as required.

The viscosity of the monomer-absorbing layer (b)-forming composition may be adjusted so as to be suitable for the application by any appropriate method.

Examples of the base material used when the monomer-absorbing layer (b) is a monomer-absorbable sheet with a base material (base material for a monomer-absorbable sheet) include: a paper-based base material such as paper; a fiber-based base material such as cloth, non-woven fabric, or net; a metal-based base material such as a metal foil or a metal plate; a plastic-based base material such as a plastic film or sheet; a rubber-based base material such as a rubber sheet; a foam body such as a foamed sheet; and a laminate thereof (such as a laminate of a plastic-based base material and any other base material or a laminate of plastic films (or sheets)). Such base material is preferably a plastic-based base material such as a plastic filth or sheet. Examples of such plastic include: an olefin-based resin containing α-olefin as a monomer component such as a polyethylene (PE), a polypropylene (PP), an ethylene-propylene copolymer, or an ethylene-vinyl acetate copolymer (EVA); a polyester-based resin such as a polyethylene terephthalate (PET), a polyethylene naphthalate (PEN), or a polybutylene terephthalate (PBT); a polyvinyl chloride (PVC); a vinyl acetate-based resin; a polyphenylene sulfide (PPS); an amide-based resin such as a polyamide (nylon) or a wholly aromatic polyamide (aramid); a polyimide-based resin; and a polyether ether ketone (PEEK). The number of kinds of such plastics may be only one, or may be two or more.

When the monomer-absorbing layer (b) is curable with an active energy ray, the base material for a monomer-absorbable sheet is preferably a sheet that does not inhibit the transmission of the active energy ray.

The surface of the base material for a monomer-absorbable sheet is preferably subjected to any appropriate surface treatment for improving its adhesiveness with the monomer-absorbing layer (b). Examples of such surface treatment include: an oxidation treatment by a chemical or physical method such as a corona treatment, a chromic acid treatment, ozone exposure, flame exposure, high-voltage electric shock exposure, or an ionizing radiation treatment; and a coating treatment with an undercoating agent, a releasing agent, or the like.

Any appropriate thickness can be adopted as the thickness of the base material for a monomer-absorbable sheet depending on, for example, its strength, flexibility, and intended use. The thickness of the base material for a monomer-absorbable sheet is, for example, preferably 400 μm or less, more preferably 1 to 350 μm, still more preferably 10 to 300 μm.

The base material for a monomer-absorbable sheet may be a single layer, or may be a laminate of two or more layers.

(2-1-1-4. Laminate (X))

The laminate (X) is obtained by laminating the polymerizable composition layer (a) and the monomer-absorbing layer (b). A method of obtaining the laminate (X) is, for example, a method involving applying the polymerizable composition (α) to the monomer-absorbing surface of the monomer-absorbing layer (b) to form the polymerizable composition layer (a), or a method involving applying the polymerizable composition (α) onto any appropriate support to form the syrupy polymerizable composition layer (a) and then transferring the polymerizable composition layer (a) onto the monomer-absorbing layer (b).

The ratio of the thickness of the polymerizable composition layer (a) to the thickness of the monomer-absorbing layer (b) is preferably 300% or less, more preferably 200% or less, still more preferably 100% or less. When the ratio of the thickness of the polymerizable composition layer (a) to the thickness of the monomer-absorbing layer (b) exceeds 300%, it may become difficult to produce the flame-retardant polymer member or a problem in that the strength of the flame-retardant polymer member after the production reduces may arise. As the ratio of the thickness of the polymerizable composition layer (a) to the thickness of the monomer-absorbing layer (b) reduces, the ease with which the layered inorganic compound (f) is unevenly distributed is improved, and hence the layered inorganic compound (f) can be unevenly distributed in the unevenly distributed polymerizable composition layer (a1) at a higher density. It should be noted that the ratio of the thickness of the polymerizable composition layer (a) to the thickness of the monomer-absorbing layer (b) is preferably set to 1% or more because the layer can be uniformly produced.

(2-1-1-5. Cover Film)

Upon production of the laminate (X), a cover film can be used as the support of the polymerizable composition layer (a). The cover film may have peelability. It should be noted that when a photopolymerization reaction is used in the polymerizing step (2), oxygen in the air is preferably blocked with the cover film in the polymerizing step (2) because the reaction is inhibited by oxygen in the air.

As the cover film, any appropriate cover film may be adopted as long as the cover film is a thin sheet which has low oxygen permeation. When a photopolymerization reaction is used, a preferred cover film is a transparent film such as any appropriate release paper. Specific examples of the cover film include a base material having a layer release-treated (peel-treated) with a release treatment agent (a peel treatment agent) on at least one of its surfaces, a low-adhesive base material formed of a fluorine-based polymer (such as a polytetrafluoroethylene, a polychlorotrifluoroethylene, a polyvinyl fluoride, a polyvinylidene fluoride, a copolymer of tetrafluoroethylene and hexafluoropropylene, or a copolymer of chlorofuluoroethylene and vinylidene fluoride), and a low-adhesive base material formed of a non-polar polymer (such as an olefin-based resin such as a polyethylene or a polypropylene). The surface of a release-treated layer of the base material having the release-treated layer on at least one of its surfaces may be used as a release surface. Each of both surfaces of the low-adhesive base material may be used as a release surface.

Examples of the base material that can be used in the base material having a release-treated layer on at least one of its surfaces include: a plastic-based base material film such as a polyester film (such as a polyethylene terephthalate film), an olefin-based resin film (such as a polyethylene film or a polypropylene film), a polyvinyl chloride film, a polyimide film, a polyamide film (nylon film), and a rayon film; papers (such as woodfree paper, Japanese paper, kraft paper, glassine paper, synthetic paper, and top coated paper); and a multi-layered laminate obtained by lamination or co-extrusion thereof (laminate of 2 to 3 layers). As such base material, a plastic-based base material film having high transparency is preferred, and a polyethylene terephthalate film is particularly preferred.

A release treatment agent that can be used in the base material having a release-treated layer on at least one of its surfaces is, for example, a silicone-based release treatment agent, a fluorine-based release treatment agent, or a long-chain alkyl-based release treatment agent. Only one kind of the release treatment agents may be used, or two or more kinds thereof may be used.

Any appropriate thickness can be adopted as the thickness of the cover film. The thickness of the cover film is, for example, preferably 12 to 250 μm, more preferably 20 to 200 μm in terms of handleability and economical efficiency.

The cover film may be a single layer, or may be a laminate of two or more layers.

(2-1-2. Heating Step)

In the production method (1), the laminate (X) obtained by laminating the polymerizable composition layer (a) and the monomer-absorbing layer (b) can be subjected to a heating step before being subjected to the polymerizing step (2). As a result of the heating step, the layered inorganic compound (f) can be unevenly distributed in the unevenly distributed polymerizable composition layer (a1) at an additionally high density, and hence such a flame-retardant polymer member that the distribution of the layered inorganic compound (f) in the unevenly distributed polymer layer (a2) is made additionally dense can be obtained.

The heating temperature is preferably 25° C. or more and 100° C. or less, more preferably 30° C. or more and 90° C. or less, still more preferably 40° C. or more and 80° C. or less, particularly preferably 50° C. or more and 80° C. or less. The time for the heating step is preferably 1 second or more and 120 minutes or less, more preferably 10 seconds or more and 60 minutes or less, still more preferably 1 minute or more and 30 minutes or less. In particular, a flame-retardant polymer member having a higher density can be obtained as the temperature increases in the heating temperature range or as the time for the heating step lengthens in the range of the time for the heating step. When the heating temperature is less than 25° C., the polymerizable monomer (m) may not be sufficiently absorbed by the monomer-absorbing layer (b). When the heating temperature exceeds 100° C., the polymerizable monomer (m) may volatilize or the cover film may deform. When the time for the heating step is less than 1 second, it may become difficult to perform the step. When the time for the heating step exceeds 120 minutes, there is a possibility that waviness occurs in the flame-retardant polymer member and hence a smooth flame-retardant polymer member is not obtained.

The polymerizable composition layer (a) and the monomer-absorbing layer (b) may be exposed to the temperature condition before the laminating step (1). The polymerizable composition (α) may also be exposed to the temperature condition.

Any appropriate heating method can be adopted as a method of heating the laminate (X) in the heating step. Examples of the method of heating the laminate (X) in the heating step include a heating method involving using an oven, a heating method involving using an electrothermal heater, and a heating method involving using an electromagnetic wave such as an infrared ray.

As a result of the laminating step (1) and the heating step to be performed as required, in the laminate (X), the layered inorganic compound (f) moves in the polymerizable composition layer (a), and the layered inorganic compound (f) is substantially absent at an interface between the polymerizable composition layer (a) and monomer-absorbing layer (b) immediately after the lamination. Thus, the unevenly distributed polymerizable composition layer (a1) is obtained, in which the layered inorganic compound (f) is unevenly distributed toward the side opposite to the monomer-absorbing layer (b). Meanwhile, the monomer-absorbing layer (b) absorbs the polymerizable monomer (m) and hence the monomer-absorbing layer (b1) is obtained.

(2-1-3. Polymerizing Step (2))

A laminate (Y) of the unevenly distributed polymer layer (a2) and the cured monomer-absorbing layer (b2) is obtained by performing the polymerizing step (2) of polymerizing the polymerizable monomer (m) in the unevenly distributed polymerizable composition layer (a1) and the polymerizable monomer (m) in the monomer-absorbing layer (b1).

The polymerizing step (2) can be performed by, for example, photoirradiation. Any appropriate condition can be adopted as a condition such as a light source, irradiation energy, an irradiation method, or an irradiation time.

An active energy ray to be used in the photoirradiation is, for example, an ionizing radiation such as an α-ray, a β-ray, a γ-ray, a neutron beam, or an electron beam, or UV light. Of those, UV light is preferred.

Irradiation with the active energy ray is performed by using, for example, a black-light lamp, a chemical lamp, a high-pressure mercury lamp, or a metal halide lamp.

Heating may be performed in the polymerizing step (2). Any appropriate heating method can be adopted as a heating method. Examples of the heating method include a heating method involving using an electrothermal heater and a heating method involving using an electromagnetic wave such as an infrared ray.

The thickness of the unevenly distributed portion (a21) of the layered inorganic compound (f) in the unevenly distributed polymer layer (a2) in the laminate (Y) is preferably 80% or less, more preferably 60% or less, still more preferably 50% or less with respect to the thickness of the polymerizable composition layer (a) (before the lamination). When the ratio of the thickness of the unevenly distributed portion (a21) of the layered inorganic compound (f) to the thickness of the polymerizable composition layer (a) (before the lamination) exceeds 80%, adhesiveness between the unevenly distributed polymer layer (a2) and the cured monomer-absorbing layer (b2) may be problematic, or the strength of the unevenly distributed polymer layer (a2) may be problematic.

The thickness of the unevenly distributed portion (a21) of the layered inorganic compound (f) can be controlled by adjusting the amount of the layered inorganic compound (f).

The unevenly distributed portion (a21) of the layered inorganic compound (f) and the non-unevenly distributed portion (a22) of the layered inorganic compound (f) can be clearly distinguished from each other because the unevenly distributed portion (a21) of the layered inorganic compound (f) has a layer shape.

A trace amount of the layered inorganic compound (f) may be dispersed in the non-unevenly distributed portion (a22) depending on a combination of the monomer-absorbing layer (b) and the polymerizable monomer (m). However, the layered inorganic compound (f) dispersed in a trace amount in the non-unevenly distributed portion (a22) does not affect any characteristic of the flame-retardant polymer member.

The unevenly distributed portion (a21) of the layered inorganic compound (f) corresponds to the flame-retardant layer (A).

In the unevenly distributed portion (a21) of the layered inorganic compound (f), the layered inorganic compound (f) and a polymer component of the unevenly distributed polymer layer (a2) are mixed. Accordingly, the unevenly distributed portion (a21) of the layered inorganic compound (f) can exert a characteristic based on the polymer component of the unevenly distributed polymer layer (a2), a characteristic of the layered inorganic compound (f), and a characteristic based on the uneven distribution of the layered inorganic compound (f) in the unevenly distributed polymer layer (a2).

Examples of the characteristic based on the polymer component of the unevenly distributed polymer layer (a2) include flexibility, hard-coat property, pressure-sensitive adhesive property, stress-relaxing property, and impact resistance. The pressure-sensitive adhesive property is, for example, pressure-sensitive adhesive property upon use of a pressure-sensitive adhesive component as the polymer component.

The characteristic of the layered inorganic compound (f) is, for example, a specific function (such as expansivity, shrink property, absorbability, divergence, or conductivity) upon use of the layered inorganic compound (f) having the specific function.

Examples of the characteristic based on the uneven distribution of the layered inorganic compound (f) in the unevenly distributed polymer layer (a2) include: the control of pressure-sensitive adhesive property by the adjustment of the content of the layered inorganic compound upon use of a pressure-sensitive adhesive component as the polymer component; design such as coloring; and the provision of surface unevenness upon use of particles as the layered inorganic compound (f) and a characteristic based on the surface unevenness (such as re-peelability, anti-blocking property, an antiglare characteristic, design, and light-scattering property).

When the polymer component of the unevenly distributed polymer layer (a2) is a pressure-sensitive adhesive component and the layered inorganic compound (f) is particulate, unevenness is formed on the surface of the unevenly distributed polymer layer (a2) by the particulate, layered inorganic compound (f), and hence a flame-retardant polymer member capable of exerting pressure-sensitive adhesive property (tackiness) and releasability (anti-blocking property) on the surface of the unevenly distributed polymer layer (a2) can be obtained. In such flame-retardant polymer member, the pressure-sensitive adhesive property (tackiness) and releasability (anti-blocking property) of the surface of the unevenly distributed polymer layer (a2) can be controlled by adjusting the amount of the particulate, layered inorganic compound (f) to be incorporated.

The particulate, layered inorganic compound (f) in the unevenly distributed portion (a21) may exist in such a manner that the entirety of the particulate, layered inorganic compound (f) is included in the unevenly distributed portion (a21), or may exist in such a manner that part of the particulate, layered inorganic compound (f) is exposed to the outside of the unevenly distributed polymer layer (a2).

(2-1-4. Thermally Functional Layer (L)-Producing Step (3))

The thermally functional layer (L) can be produced by any appropriate method. Preferred examples of the method of producing the thermally functional layer (L) include: a method involving forming the thermally functional layer (L) described in the section <1-5. Thermally functional layer (L)> (which may contain an additive described in the section <1-5. Thermally functional layer (L)>) on the flame-retardant layer (A); and a method involving transferring the thermally functional layer (L) (which may contain an additive described in the section <1-5. Thermally functional layer (L)>) formed on any appropriate base material onto the flame-retardant layer (A). In addition, the thermally functional layer (L) may be formed by using any appropriate paint.

The thermally functional layer (L)-producing step (3) can be performed at any appropriate timing in the production method (1)

(2-1-4-1. Heat-Shielding Layer-Producing Step (3))

The heat-shielding layer can be produced by any appropriate method.

When the heat-shielding layer (L) is an applied layer, the heat-shielding layer (L) can be formed by applying any appropriate heat-shielding paint. Specifically, for example, the heat-shielding layer (L) is formed by applying a heat-shielding paint to the surface of a layer to serve as the flame-retardant layer (A). After its application, the heat-shielding paint is dried as required. A commercially available heat-shielding paint may be used as the heat-shielding paint, or the paint can be prepared by mixing any appropriate heat-shielding substance and, as required, any other additive with any appropriate solvent. The solvent is preferably, for example, an organic solvent or water. Only one kind of solvent may be used as the solvent, or a mixed solvent of two or more kinds of solvents may be used as the solvent. When the heat-shielding substance and, as required, any other additive are mixed with the solvent, the heat-shielding substance may be mixed in a powder state, or may be mixed in a slurry state or a sol state.

Any appropriate means can be adopted as means for applying the heat-shielding paint. Examples of such means include gravure coating, spray coating, and dip coating. After the application of the heat-shielding paint, the applied product can be dried as required. A heating temperature for the drying is preferably 50 to 200° C. A heating time for the drying is preferably 10 seconds to 60 minutes. After the performance of the drying, aging may be performed for a necessary time period. The aging can improve the peel strength of the coating film with which the flame-retardant layer (A) is coated.

When the heat-shielding layer (L) is a sheet layer, the sheet layer can be formed by any appropriate forming method. Specifically, for example, a sheet-shaped product is formed by any appropriate forming method and the sheet-shaped product is attached to the surface of a layer to serve as the flame-retardant layer (A).

When the heat-shielding layer (L) is a foil layer, specifically, for example, a foil-shaped product such as a metal foil is prepared in advance and the foil-shaped product is attached to the surface of a layer to serve as the flame-retardant layer (A).

When the heat-shielding layer (L) is a sputtered layer, the layer can be, for example, formed by any appropriate sputtering method.

When the heat-shielding layer (L) is a deposited layer, the layer can be, for example, formed by any appropriate deposition method.

(2-1-4-2. Heat-Conductive Layer-Producing Step (3))

The heat-conductive layer can be produced by any appropriate method.

When the heat-conductive layer (L) is an applied layer, the heat-conductive layer (L) can be formed by applying any appropriate heat-conductive liquid. Specifically, for example, the heat-conductive layer (L) is formed by applying a heat-conductive liquid to the surface of a layer to serve as the flame-retardant layer (A). After its application, the heat-conductive liquid is dried as required. A commercially available heat-conductive liquid may be used as the heat-conductive liquid, or the liquid can be prepared by mixing any appropriate heat-conductive substance and, as required, any other additive with any appropriate solvent. The solvent is preferably, for example, an organic solvent or water. Only one kind of solvent may be used as the solvent, or a mixed solvent of two or more kinds of solvents may be used as the solvent. When the heat-conductive substance and, as required, the other additive are mixed with the solvent, the heat-conductive substance may be mixed in a powder state, or may be mixed in a slurry state or a sol state.

Any appropriate means can be adopted as means for applying the heat-conductive liquid. Examples of such means include gravure coating, spray coating, and dip coating.

After the application of the heat-conductive liquid, the applied product can be dried as required. A heating temperature for the drying is preferably 50 to 200° C. A heating time for the drying is preferably 10 seconds to 60 minutes.

After the performance of the drying, aging may be performed for a necessary time period. The aging can improve the peel strength of the coating film with which the flame-retardant layer (A) is coated.

When the heat-conductive layer (L) is a sheet layer, the sheet layer can be formed by any appropriate forming method. Specifically, for example, a sheet-shaped product is formed by any appropriate forming method and the sheet-shaped product is attached to the surface of a layer to serve as the flame-retardant layer (A).

(2-1-4-3. Heat-Insulating Layer-Producing Step (3))

The heat-insulating layer can be produced by any appropriate method. The heat-insulating layer can be preferably produced by: applying a resin composition (such as a resin composition containing hollow bead structures) as a formation material; and drying the composition as required. Any appropriate solvent may be added as required upon application of the resin composition as a formation material.

Any appropriate means can be adopted as means for applying the resin composition. Examples of such means include gravure coating, spray coating, and dip coating.

When the resin composition is dried after its application, a heating temperature for the drying is preferably 30 to 180° C., more preferably 50 to 150° C. A heating time for the drying is preferably 10 seconds to 10 minutes.

After the application of the resin composition, the heat-insulating layer may be cured by, for example, UV irradiation or heating as required. For example, when a resin composition containing a UV-curable resin is used, the layer is preferably cured by UV irradiation, and when a resin composition containing a thermosetting resin is used, the layer is preferably cured by heating.

After its production, the heat-insulating layer may be aged for a necessary time period. The aging can improve the peel strength of the coating film with which the flame-retardant layer (A) is coated.

<2-2. Flame-Retardant Polymer Member Production Method (2)>

In addition to the production method (1), a production method (2) is preferably adopted as the method of producing the flame-retardant polymer member of the present invention. In the production method (2), the flame-retardant polymer member of the present invention is produced by a production method including the step of laminating a solid layered inorganic compound-containing polymer layer (aₚ), which is obtained by polymerizing a polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m) and the step of producing the thermally functional layer (L).

The solid layered inorganic compound-containing polymer layer (aₚ) can be obtained by: producing the polymerizable composition layer (a) by the same method as the method described in the production method (1); and then performing the polymerization of the polymerizable composition layer (a) by the same method as that in the polymerizing step (2) described in the production method (1). Although the solid layered inorganic compound-containing polymer layer (aₚ) contains a polymer component formed by the polymerization of the polymerizable monomer (m), the polymerizable monomer (m) that has not been polymerized may remain in the layer.

The solid monomer-absorbing layer (b) can be obtained by the same method as the method described in the production method (1).

The lamination of the solid layered inorganic compound-containing polymer layer (aₚ) and the solid monomer-absorbing layer (b) can be performed by any appropriate lamination method. A method for the lamination of the solid layered inorganic compound-containing polymer layer (aₚ) and the solid monomer-absorbing layer (b) is, for example, a method involving producing the solid layered inorganic compound-containing polymer layer (aₚ) on any appropriate base material, separately preparing the monomer-absorbing layer (b) to be provided as a monomer-absorbable sheet, and laminating the layers.

The step of producing the thermally functional layer (L) is, for example, the same step as that described in (2-1-4. Thermally functional layer (L)-producing step (3)). It should be noted that the thermally functional layer (L)-producing step (3) can be performed at any appropriate timing in the production method (2).

<2-3. Flame-Retardant Polymer Member Production Method (3)>

In addition to the production methods (1) and (2), a production method (3) is preferably adopted as the method of producing the flame-retardant polymer member of the present invention. In the production method (3), the flame-retardant polymer member of the present invention is produced by a production method including the step of laminating a syrupy polymerizable composition layer (a′) formed of a polymerizable composition (α) containing a polymerizable monomer (m1) and the layered inorganic compound (f), and a syrupy polymerizable composition layer (b′) containing a polymerizable monomer (m2) and a polymer (p2), followed by the performance of polymerization, and the step of producing the thermally functional layer (L).

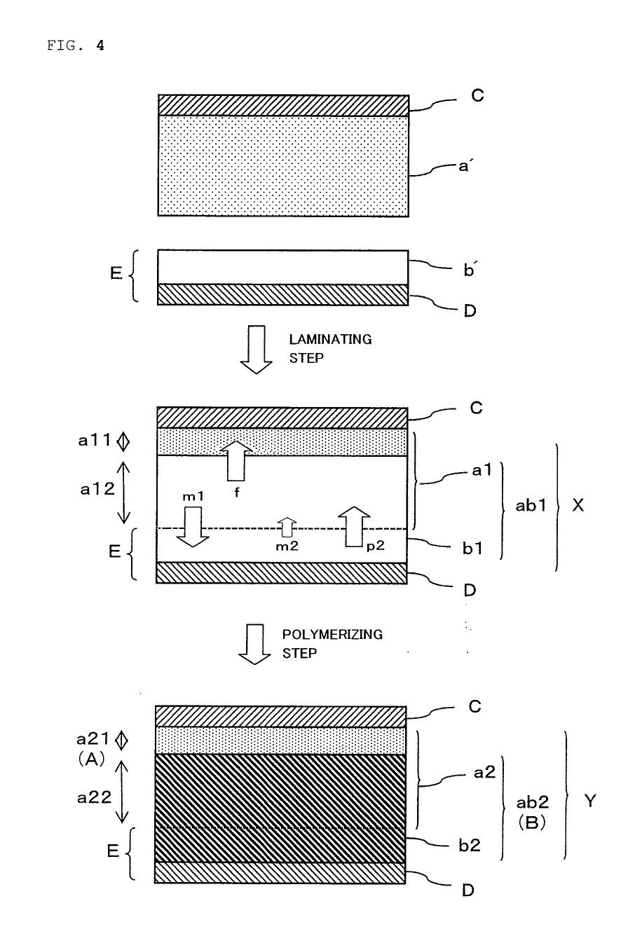

Hereinafter, the “step of laminating the syrupy polymerizable composition layer (a′) formed of the polymerizable composition (α) containing the polymerizable monomer (m1) and the layered inorganic compound (f), and the syrupy polymerizable composition layer (b′) containing the polymerizable monomer (m2) and the polymer (p2), followed by the performance of polymerization” in the flame-retardant polymer member production method (3) is described with reference to FIG. 4.

First, in a laminating step (1), a laminate (X) is obtained by laminating the polymerizable composition layer (a′) and the polymerizable composition layer (b′). The polymerizable composition layer (a′) contains the polymerizable monomer (m1) and the layered inorganic compound (f). The polymerizable composition layer (b′) contains the polymerizable monomer (m2) and the polymer (p2). Although the polymerizable composition layer (a′) can be laminated on at least one surface of the polymerizable composition layer (b′), FIG. 4 illustrates the case where the layer is laminated only on one surface of the polymerizable composition layer (b′). In FIG. 4, a cover film (C) is provided on the side of the polymerizable composition layer (a′) not laminated on the polymerizable composition layer (b′). In addition, in FIG. 4, the polymerizable composition layer (b′) is provided on a base material film (D).

It is preferred that the polymerizable monomer (m1) in the polymerizable composition layer (a′), and the polymerizable monomer (m2) and the polymer (p2) in the polymerizable composition layer (b′) substantially show compatibility. Thus, in the laminate (X), part of the polymerizable monomer (m1) and part of the polymerizable monomer (m2) can each diffuse in the other layer interactively on the lamination surface of the polymerizable composition layer (a′) and the polymerizable composition layer (b′). Here, when a concentration (c1) of the polymerizable monomer (m1) in the polymerizable composition layer (a′) is higher than a concentration (c2) of the polymerizable monomer (m2) in the polymerizable composition layer (b′), the extent to which the polymerizable monomer (m1) diffuses in the polymerizable composition layer (b′) enlarges, and in accordance therewith, the extent to which the polymer (p2) in the polymerizable composition layer (b′) diffuses in the polymerizable composition layer (a′) enlarges. On the other hand, in the polymerizable composition layer (a′), the unevenly distributed polymerizable composition layer (a1) is obtained, in which the layered inorganic compound (f) is unevenly distributed toward the side opposite to the polymerizable composition layer (b′), and which has, as a result of the distribution, the unevenly distributed portion (a11) and non-unevenly distributed portion (a12) of the layered inorganic compound (f).

The concentration (c1) of the polymerizable monomer (m1) in the polymerizable composition layer (a′) is preferably higher than the concentration (c2) of the polymerizable monomer (m2) in the polymerizable composition layer (b′). A concentration difference between the concentration (c1) and the concentration (c2) is preferably 15 wt % or more, more preferably 20 wt % or more, still more preferably 30 wt % or more. When the concentration difference between the concentration (c1) and the concentration (c2) is set to 15 wt % or more, the layered inorganic compound (f) in the polymerizable composition layer (a′) can be unevenly distributed in an effective manner. It should be noted that when the concentration (c2) is higher than the concentration (c1), there is a possibility that the layered inorganic compound (f) in the polymerizable composition layer (a′) cannot be unevenly distributed in a sufficient manner.

The phenomenon of the uneven distribution of the layered inorganic compound (f) in the unevenly distributed polymerizable composition layer (a1) is assumed to be caused by the diffusion of the polymer (p2) from the polymerizable composition layer (b′). The polymerizable monomer (m1) diffuses in the polymerizable composition layer (b′), and in the meantime, the polymer (p2) diffuses in the polymerizable composition layer (a′). Thus, the layered inorganic compound (f) that cannot diffuse toward the polymerizable composition layer (b′) may be unevenly distributed in such a manner as to remain in the polymerizable composition layer (a′). The polymerizable composition layer (b′) absorbs the polymerizable monomer (m1) to turn into the monomer-absorbing layer (b1).

Each component of the polymerizable composition layer (a′) and each component of the polymerizable composition layer (b′) diffuse interactively in the laminate (X). Accordingly, an interface between the non-unevenly distributed portion (a12) of the layered inorganic compound (f) in the unevenly distributed polymerizable composition layer (a1) and the monomer-absorbing layer (b1) cannot be observed (a composite site of these layers is represented as abl in FIG. 4). In FIG. 4, the interface is indicated by a broken line for convenience.

Next, the polymerizable monomer (m1) and the polymerizable monomer (m2) in the unevenly distributed polymerizable composition layer (a1) and the monomer-absorbing layer (b1) are polymerized by subjecting the laminate (X) to the polymerizing step (2). Thus, the laminate (Y) in which the unevenly distributed polymer layer (a2), which has been cured while the unevenly distributed structure has been maintained, and the cured monomer-absorbing layer (b2) are laminated is obtained. The unevenly distributed polymer layer (a2) has the unevenly distributed portion (a21) of the layered inorganic compound (f) and the non-unevenly distributed portion (a22) of the layered inorganic compound (f). It should be noted that the monomer-absorbing layer (b1) is turned into the monomer-absorbing layer (b2), in which the polymerizable monomer (m1) and the polymerizable monomer (m2) have been cured, by the polymerizing step (2) because the polymerizable monomer (m1) and the polymerizable monomer (m2) are absorbed by the monomer-absorbing layer (b1). Although an interface between the non-unevenly distributed portion (a22) of the layered inorganic compound (f) in the unevenly distributed polymer layer (a2) and the cured monomer-absorbing layer (b2) cannot be observed in the laminate (Y) (a composite site of these layers is represented as ab2 in FIG. 4), the interface is indicated by a broken line in FIG. 4 for convenience.

Details about the laminating step (1) and details about the polymerizing step (2) are identical to those described in the production method (1). In addition, the heating step described in the production method (1) may be included.

The step of producing the thermally functional layer (L) is, for example, the same step as the thermally functional layer (L)-producing step (3) described in the production method (1). It should be noted that the thermally functional layer (L)-producing step (3) can be performed at any appropriate timing in the production method (3).

<<3. Shape of Flame-Retardant Polymer Member>>

Any appropriate shape can be adopted as the shape of the flame-retardant polymer member of the present invention. Examples of the shape of the flame-retardant polymer member of the present invention include a sheet shape and a tape shape. When the shape of the flame-retardant polymer member of the present invention is a sheet shape, the member can be used as a flame-retardant sheet. The flame-retardant polymer member of the present invention may have such a shape that the member of a sheet shape or a tape shape is wound in a roll shape. Alternatively, the flame-retardant polymer member of the present invention may have such a shape that members of sheet shapes or tape shapes are laminated.

When the outermost layer of the flame-retardant polymer member of the present invention is a pressure-sensitive adhesive layer, the flame-retardant polymer member of the present invention can be used as a pressure-sensitive adhesive tape or a pressure-sensitive adhesive sheet. It should be noted that the “tape” and the “sheet” may be collectively referred to as “tape” or “sheet” in a simple manner.

The flame-retardant polymer member of the present invention can also be used as a pressure-sensitive adhesive tape or a pressure-sensitive adhesive sheet by further providing the flame-retardant polymer member of the present invention with a pressure-sensitive adhesive layer formed of any appropriate pressure-sensitive adhesive (such as an acrylic pressure-sensitive adhesive, a rubber-based pressure-sensitive adhesive, a vinyl alkyl ether-based pressure-sensitive adhesive, a silicone-based pressure-sensitive adhesive, a polyester-based pressure-sensitive adhesive, a polyamide-based pressure-sensitive adhesive, a urethane-based pressure-sensitive adhesive, a fluorine-based pressure-sensitive adhesive, or an epoxy-based pressure-sensitive adhesive).

The flame-retardant polymer member of the present invention may have any other layer (such as an intermediate layer or an undercoat layer) to such an extent that the effect of the present invention is not impaired.

In the flame-retardant polymer member of the present invention, the surface of the thermally functional layer (L) may be protected with a cover film. The cover film can be peeled upon use of the flame-retardant polymer member of the present invention.

<<4. Flame-Retardant Article>>

A flame-retardant article is obtained by attaching the flame-retardant polymer member of the present invention to an adherend. For example, paper, lumber, a plastic material, a metal, a plaster board, glass, or a composite containing two or more thereof can be used as the adherend. The flame-retardant polymer member of the present invention is attached to at least part of the adherend. It should be noted that the adherend may be a printed matter provided with a pattern layer or the like, or may be an adherend having design.

Examples of the paper as the adherend include woodfree paper, Japanese paper, kraft paper, glassine paper, synthetic paper, and top-coated paper.

Examples of the lumber as the adherend include: broadleaf trees such as oak, paulownia wood, keyaki, teak, and rosewood; coniferous trees such as Japanese cedar, Japanese cypress, pine, and hiba false arborvitae; assembles; and plywood.

Examples of the plastic material as the adherend include an acrylic resin, a polyester (such as a polyethylene terephthalate), an olefin-based resin (such as a polyethylene, a polypropylene, or a polystyrene), a vinyl chloride resin, an epoxy resin, a vinyl ether-based resin, and a urethane-based resin.

Upon lamination of the flame-retardant polymer member of the present invention and the adherend, the member and the adherend may be attached to each other by applying any appropriate pressure-sensitive adhesive by any appropriate application method. When the outermost layer of the flame-retardant polymer member is a pressure-sensitive adhesive layer, the member may be attached to the adherend without being treated. A method of attaching the flame-retardant polymer member and the adherend is, for example, a method involving attaching the member and the adherend with a laminator. The flame-retardant-treated adherend thus obtained can be attached to a wall surface or glass surface of a railway vehicle or the like, or to a wall surface, decorative laminate, glass surface, or the like of a housing or the like through an attachment layer, the attachment layer being provided on the surface opposite to the surface on which the flame-retardant polymer member of the present invention is laminated.

The flame-retardant polymer member of the present invention can be suitably used as a building material in, for example, a wall material, ceiling material, roofing material, flooring material, partitioning material, or curtain of a housing, edifice, or public facility, in particular, a wall material or ceiling material of a kitchen, or a partition of a clean room. In addition, the member can be used in, for example, a surface trim material for fire preventive equipment such as an exhaust duct, a fire door, or a fire shutter, a surface trim material for furniture such as a table, a surface trim material for a door, a surface trim material for window glass, a surface trim material for a signboard or digital signage, or a roll screen. In addition, the member can be used in a wall material, ceiling material, roofing material, or flooring material inside or outside a ship, aircraft, automobile, or railway vehicle, a surface protective material or inkjet media material for a printed matter to be attached to a glass portion inside or outside a railway vehicle, a solar cell member, a cell protective material, or an electrical and electronic equipment member such as a partition inside an electrical apparatus. Further, the member can be used as a peripheral tool for an ash tray, a surface trim material for a garbage box, or a protective material for the front panel of a pachinko machine.

### EXAMPLES

Hereinafter, the present invention is described in more detail by way of examples, but the present invention is not limited to these examples.

It should be noted that a biaxially stretched polyethylene terephthalate film having a thickness of 38 μm (trade name: “MRN38,” manufactured by Mitsubishi Chemical Polyester Film) one surface of which had been subjected to a silicone-based release treatment was used as each of cover films and base material films used in the following respective examples.

<Flame Retardancy>

A polymer sheet was evaluated for the following flame retardancy.

An evaluation for flame retardancy was performed by the horizontal firing test illustrated in FIG. 2. FIG. 2 illustrates a measurement method. Each polymer sheet was cut into a piece measuring 5 cm by 12 cm and then the piece was subjected to the evaluation. It should be noted that the cover films on both surfaces of each polymer sheet were peeled.

In each of the thermally functional flame-retardant polymer sheets obtained in Examples, the side of the thermally functional layer was defined as a lower surface, and in a flame-retardant polymer Sheet (C1) obtained in Comparative Example, the side of the flame-retardant layer was defined as a lower surface.

A Bunsen burner was placed so that the flame port of the Bunsen burner was positioned at a lower portion distant from the central portion of the lower surface of a polymer sheet by 45 mm, and then the flame of the Bunsen burner having a height of 55 mm from the flame port was brought into contact for 30 seconds. A propane gas was used as the gas of the Bunsen burner and the test was performed in the air.

<<Flame Retardancy: *1>>

A polymer sheet was evaluated for its flame retardancy on the basis of the following criteria by subjecting the polymer sheet to the horizontal firing test and observing the presence or absence of the combustion of the polymer sheet.

◯: The polymer sheet does not ignite even after 30 seconds from the flame contact, and maintains its shape.
Δ: The polymer sheet ignites within 30 seconds from the flame contact, but maintains its shape.
x: The polymer sheet ignites within 30 seconds from the flame contact, and does not maintain its shape.

<<Flame-Blocking Property: *2>>

A polymer sheet was evaluated for its flame-blocking property by: placing a White Economy 314-048 (manufactured by Biznet) as copy paper at a position 3 mm above the polymer sheet; and observing the presence or absence of the combustion of the copy paper through the same horizontal firing test as that described above.

◯: The copy paper 3 mm above the polymer sheet does not ignite even after 30 seconds from the flame contact.
Δ: The copy paper 3 mm above the polymer sheet ignites within 30 seconds from the flame contact, but does not ignite within 10 seconds therefrom.
x: The copy paper 3 mm above the polymer sheet ignites within 10 seconds from the flame contact.

<Heat-Shielding Property: *3>

A temperature sensor was attached to the back surface on the polymer layer (B) side. The resultant was irradiated with light from a position 30 cm vertically above its heat-shielding layer (L) side (frame-retardant layer (A) side in the case where the heat-shielding layer (L) was not provided) by using an REF-lamp, and then the temperature at the time point when an increase in temperature of the back surface reached a saturated state was measured.

<Heat Conductivity>

<<Solar Absorptivity: *3>>

A measurement site was exposed, and then a spectral reflectance was measured with a spectrophotometer in conformity with JIS-A-5759. After that, a solar reflectance was determined as a weighted average with a solar spectral distribution, and “(100-solar reflectance)” was adopted as a solar absorptivity. The solar absorptivity was used as an indicator for heat conductivity.

<<Heat Conduction Coefficient: *4>>

A measurement site was exposed, and then a heat conduction coefficient was measured with a heat conduction coefficient measuring apparatus (manufactured by KYOTO ELECTRONICS MANUFACTURING CO., LTD., QTM-500).

<Heat-Insulating Property: *3>

A polymer sheet was floated on ice water at 0° C. with its polymer layer side directed downward in a room having a room temperature of 10° C. and a relative humidity of 30% RH. The surface temperature of the polymer sheet was measured and then the presence or absence of dew condensation was visually observed.

### Synthesis Example 1

### Preparation of Syrup (b-1)

50 Parts by weight of isobornyl acrylate, 50 parts by weight of lauryl acrylate, 0.1 part by weight of a photopolymerization initiator (trade name: “IRGACURE 651,” manufactured by Ciba Specialty Chemicals Inc.), and 0.1 part by weight of a photopolymerization initiator (trade name: “IRGACURE 184,” manufactured by Ciba Specialty Chemicals Inc.) were stirred in a four-necked separable flask provided with a stirring machine, a temperature gauge, a nitrogen gas-introducing tube, and a cooling tube until the mixture became uniform. After that, bubbling was performed with a nitrogen gas for 1 hour to remove dissolved oxygen. After that, UV light was applied from the outside of the flask by using a black-light lamp to perform polymerization. At the time point when a moderate viscosity was obtained, the lamp was turned off and the blowing of nitrogen was stopped. Thus, a syrupy composition having a rate of polymerization of 7% part of which had been polymerized was prepared (hereinafter, the composition is referred to as “syrup (b-1)”).

### Synthesis Example 2

### Preparation of Syrup (a-1) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 100 parts by weight of cyclohexyl acrylate, 0.2 part by weight of 1,6-hexanediol diacrylate, 0.2 part by weight of a photopolymerization initiator (trade name: “IRGACURE 651,” manufactured by Ciba Specialty Chemicals Inc.), and 0.2 part by weight of a photopolymerization initiator (trade name: “IRGACURE 184,” manufactured by Ciba Specialty Chemicals Inc.), and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-1) containing a layered inorganic compound was prepared. It should be noted that the monomer mixture to which the layered clay mineral had been added became transparent as a result of the ultrasonic treatment.

### Synthesis Example 3

### Production of Monomer-Absorbable Sheet (B-1) with Base Material

A syrup composition prepared by uniformly mixing 100 parts by weight of the syrup (b-1) prepared in Synthesis Example 1 with 0.5 part by weight of a photopolymerization initiator (trade name: “IRGACURE 651,” manufactured by Ciba Specialty Chemicals Inc.) was applied to the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes. As a result, the layer was cured to form a monomer-absorbing layer. Thus, a monomer-absorbable sheet (B-1) with a base material in which the surface of the monomer-absorbing layer was protected with the cover film was produced.

### Synthesis Example 4

### Production of Flame-Retardant Polymer Sheet (P-1)

A polymerizable composition layer (thickness: 100 μm) was formed by applying the syrup (a-1) to the release-treated surface of the cover film. The resultant was attached to the monomer-absorbable sheet (B-1) with a base material, the monomer-absorbing layer of which had been exposed by peeling the cover film, in such a manner that the monomer-absorbing layer and the polymerizable composition layer were in contact with each other. Thus, a laminate was formed.

Next, the laminate was left to stand at room temperature for 15 minutes. Thus, an unevenly distributed polymerizable composition layer was obtained. After that, both of its surfaces were irradiated with UV light (illuminance: 5 mW/cm²) by using a black-light lamp as a light source for 5 minutes. As a result, the unevenly distributed polymerizable composition layer was photo-cured to form an unevenly distributed polymer layer. Thus, a flame-retardant polymer sheet (P-1) was produced.

### Synthesis Example 5

### Preparation of Syrup (a-2) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 100 parts by weight of 1,6-hexanediol diacrylate and 0.5 part by weight of a photopolymerization initiator (trade name: “IRGACURE 819,” manufactured by Ciba Specialty Chemicals Inc.), and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-2) containing a layered inorganic compound was prepared.

### Synthesis Example 6

### Preparation of Acrylic Oligomer (A)

70 Parts by weight of isobornyl acrylate, 30 parts by weight of lauryl acrylate, and 3.8 parts by weight of thioglycolic acid were stirred in a four-necked separable flask provided with a stirring machine, a temperature gauge, a nitrogen gas-introducing tube, and a cooling tube until the mixture became uniform. After that, bubbling was performed with a nitrogen gas for 1 hour to remove dissolved oxygen. After that, the temperature was increased to 70° C., and the mixture was stirred at 70° C. for 30 minutes. Then, 0.05 part by weight of a thermal polymerization initiator (trade name: “PERHEXYL O,” manufactured by NOF CORPORATION) and 0.02 part by weight of a thermal polymerization initiator (trade name: “PERHEXYL D,” manufactured by NOF CORPORATION) were added. The temperature was further increased to 100° C., the mixture was stirred at 100° C. for 60 minutes, and then the temperature was increased to 140° C. After that, the mixture was stirred at 140° C. for 60 minutes, the temperature was then increased to 180° C., and the mixture was stirred at 180° C. for 60 minutes. Thus, an acrylic oligomer (A) was prepared. It should be noted that the weight-average molecular weight of the resultant acrylic oligomer (A) was 5,000.

### Synthesis Example 7

### Preparation of Syrup (b-2)

20 Parts by weight of cyclohexyl acrylate, 80 parts by weight of the acrylic oligomer (A) prepared in Synthesis Example 6, and 0.5 part by weight of a photopolymerization initiator (trade name: “IRGACURE 819,” manufactured by Ciba Specialty Chemicals Inc.) were stirred in a flask provided with a stirring machine until the mixture became uniform. Thus, a syrupy composition was prepared (hereinafter, the composition is referred to as “syrup (b-2)”).

### Synthesis Example 8

### Production of Flame-Retardant Polymer Sheet (P-2)

The syrup (a-2) was applied onto a supporting base material so that its thickness after curing was 50 μm. Thus, the polymerizable composition layer (a′) was formed. The syrup (b-2) was applied onto another supporting base material so that its thickness after curing was 50 μm. Thus, the polymerizable composition layer (b′) was formed. The polymerizable composition layer (a′) and the polymerizable composition layer (b′) were attached to each other in such a manner that no air bubble was included while the layers were brought into contact with each other, and 5 minutes after the attachment, the resultant was irradiated with UV light (illuminance: 9 mW/cm², light quantity: 1,200 mJ/cm²) by using a black-light lamp and a metal halide lamp to cure the polymerizable composition layer (a′) and the polymerizable composition layer (b′). Thus, a flame-retardant polymer sheet (P-2) having the supporting base materials on both sides thereof was produced.

### Example 1-1

### Production of Heat-Shielding Flame-Retardant Polymer Sheet (1)

100 Parts by weight of a heat-shielding paint (manufactured by NIHON TOKUSHU TORYO CO., LTD., Para-Thermo) were applied onto the flame-retardant layer of the flame-retardant polymer sheet (P-1) obtained in Synthesis Example 4, and were then dried at 100° C. for 5 minutes. Thus, a heat-shielding flame-retardant polymer sheet (1) was produced.

In the resultant heat-shielding flame-retardant polymer sheet (1), the thickness of the polymer layer (B) was 175 μm, the thickness of the flame-retardant layer (A) was 15 μm, and the thickness of the heat-shielding layer (L) was 5 μm.

### Example 1-2

### Production of Heat-Shielding Flame-Retardant Polymer Sheet (2)

100 Parts by weight of a heat-shielding paint (manufactured by NIHON TOKUSHU TORYO CO., LTD., Para-Thermo) were applied onto the flame-retardant layer of the flame-retardant polymer sheet (P-2) obtained in Synthesis Example 8, and were then dried at 100° C. for 5 minutes. Thus, a heat-shielding flame-retardant polymer sheet (2) was produced.

In the resultant heat-shielding flame-retardant polymer sheet (2), the thickness of the polymer layer (B) was 85 μm, the thickness of the flame-retardant layer (A) was 15 μm, and the thickness of the heat-shielding layer (L) was 5 μm.

### Comparative Example 1

### Production of Flame-Retardant Polymer Sheet (C1)

The cover film on the flame-retardant layer side of the flame-retardant polymer sheet (P-1) obtained in Synthesis Example was peeled to expose the flame-retardant layer. Thus, a flame-retardant polymer sheet (C1) was obtained.

In the resultant flame-retardant polymer sheet (C1), the thickness of the polymer layer (B) was 175 μm and the thickness of the flame-retardant layer (A) was 25 μm.

The polymer sheets of the examples and the comparative example were subjected to the evaluations. Table 1 shows the results.

TABLE 1

| | | | Heat- |
|---|---|---|---|
| | | Flame- | shielding |
| | Flame | blocking | property^{*3} |
| | retardancy^{*1} | property^{*2} | (° C.) |
| Example 1-1 | ∘ | ∘ | 67 |
| Example 1-2 | ∘ | ∘ | 65 |
| Comparative | ∘ | ∘ | 90 |
| Example 1 | | | |

Each of the heat-shielding flame-retardant polymer sheet (1) obtained in Example 1-1 and the heat-shielding flame-retardant polymer sheet (2) obtained in Example 1-2 has excellent heat-shielding property, and at the same time, has a high level of flame retardancy.

### Example 2-1

### Production of Heat-Conductive Flame-Retardant Polymer Sheet (1)

A black paint (manufactured by JAPAN SENSOR CORPORATION, JSC-3) was applied onto the flame-retardant layer of the flame-retardant polymer sheet (P-1) obtained in Synthesis Example 4, and was then dried at 100° C. for 1 minute. Thus, a heat-conductive flame-retardant polymer sheet (1) was produced.

In the resultant heat-conductive flame-retardant polymer sheet (1), the thickness of the polymer layer (B) was 175 μm, the thickness of the flame-retardant layer (A) was 25 μm, and the thickness of the heat-conductive layer (L) was 5 μm.

### Example 2-2

### Production of Heat-Conductive Flame-Retardant Polymer Sheet (2)

A black paint (manufactured by JAPAN SENSOR CORPORATION, JSC-3) was applied onto the flame-retardant layer of the flame-retardant polymer sheet (P-2) obtained in Synthesis Example 8, and was then dried at 100° C. for 1 minute. Thus, a heat-conductive flame-retardant polymer sheet (2) was produced.

In the resultant heat-conductive flame-retardant polymer sheet (2), the thickness of the polymer layer (B) was 85 μm, the thickness of the flame-retardant layer (A) was 15 μm, and the thickness of the heat-conductive layer (L) was 5 μm.

The polymer sheets of the examples and the comparative example were subjected to the evaluations. Table 2 shows the results.

TABLE 2

| | | | | Heat |
|---|---|---|---|---|
| | | Flame- | Solar | conduction |
| | Flame | blocking | absorptivity^{*3} | coefficient^{*4} |
| | retardancy^{*1} | property^{*2} | (%) | (W/mK) |
| Example 2-1 | ∘ | ∘ | 88 | 1.05 |
| Example 2-2 | ∘ | ∘ | 89 | 1.10 |
| Comparative | ∘ | ∘ | 32 | 0.19 |
| Example 1 | | | | |

Each of the heat-conductive flame-retardant polymer sheet (1) obtained in Example 2-1 and the heat-conductive flame-retardant polymer sheet (2) obtained in Example 2-2 has excellent heat conductivity, and at the same time, has a high level of flame retardancy.

### Example 3-1

### Production of Heat-Insulating Flame-Retardant Polymer Sheet (1)

A heat-insulating paint (acrylic resin emulsion paint containing glass beads, trade name: “Sun Coat Thermo Shield,” manufactured by NAGASHIMA SPECIAL PAINT CO., LTD.) was applied onto the flame-retardant layer of the flame-retardant polymer sheet (P-1) obtained in Synthesis Example 4, and was then dried at 100° C. for minutes to form the heat-insulating layer (L). Thus, a heat-insulating flame-retardant polymer sheet (1) was produced.

In the resultant heat-insulating flame-retardant polymer sheet (1), the thickness of the polymer layer (B) was 175 μm, the thickness of the flame-retardant layer (A) was 25 μm, and the thickness of the heat-insulating layer (L) was 5 μm.

### Example 3-2

### Production of Heat-Insulating Flame-Retardant Polymer Sheet (2)

A heat-insulating paint (acrylic resin emulsion paint containing glass beads, trade name: “Sun Coat Thermo Shield,” manufactured by NAGASHIMA SPECIAL PAINT CO., LTD.) was applied onto the flame-retardant layer of the flame-retardant polymer sheet (P-2) obtained in Synthesis Example 8, and was then dried at 100° C. for minutes to form the heat-insulating layer (L). Thus, a heat-insulating flame-retardant polymer sheet (2) was produced.

In the resultant heat-insulating flame-retardant polymer sheet (2), the thickness of the polymer layer (B) was 85 μm, the thickness of the flame-retardant layer (A) was 15 μm, and the thickness of the heat-insulating layer (L) was 5 μm.

The polymer sheets of the examples and the comparative example were subjected to the evaluations. Table 3 shows the results.

TABLE 3

| | | | Heat-insulating | |
|---|---|---|---|---|
| | | | property^{*3} | |
| | | | | Presence or |
| | | Flame- | Surface | absence of |
| | Flame | blocking | temperature | dew |
| | retardancy^{*1} | property^{*2} | (° C.) | condensation |
| Example 3-1 | ∘ | ∘ | 7 | Absent |
| Example 3-2 | ∘ | ∘ | 7 | Absent |
| Comparative | ∘ | ∘ | 1 | Present |
| Example 1 | | | | |

Each of the heat-insulating flame-retardant polymer sheet (1) obtained in Example 3-1 and the heat-insulating flame-retardant polymer sheet (2) obtained in Example 3-2 has excellent heat-insulating property, and at the same time, has a high level of flame retardancy.

### INDUSTRIAL APPLICABILITY

The thermally functional flame-retardant polymer member of the present invention can make various adherends flame-retardant, and at the same time, can impart thermal functionality to the various adherends, by being attached to the various adherends.

### REFERENCE SIGNS LIST

A flame-retardant layer
B polymer layer
L thermally functional layer
a polymerizable composition layer
a′ polymerizable composition layer
a1 unevenly distributed polymerizable composition layer
a2 unevenly distributed polymer layer
a11, a21 unevenly distributed portion of layered inorganic compound
a12, a22 non-unevenly distributed portion of layered inorganic compound
b monomer-absorbing layer
b′ polymerizable composition layer
b1 monomer-absorbing layer
b2 cured monomer-absorbing layer
C cover film
D base material film
E monomer-absorbable sheet with base material
X laminate
f incompatible layered inorganic compound
m1 polymerizable monomer
m2 polymerizable monomer
p2 polymer

1. A thermally functional flame-retardant polymer member, comprising a polymer layer (B), a flame-retardant layer (A), and a thermally functional layer (L) in the stated order, wherein the flame-retardant layer (A) comprises a layer containing a layered inorganic compound (f) in a polymer.

2. A thermally functional flame-retardant polymer member according to claim 1, wherein the thermally functional layer (L) has a thickness of 0.1 to 200 μm.

3. A thermally functional flame-retardant polymer member according to claim 1, wherein in a horizontal firing test involving horizontally placing the flame-retardant polymer member with its side of the thermally functional layer (L) as a lower surface so that the lower surface is in contact with air, placing a Bunsen burner so that a flame port of the Bunsen burner is positioned at a lower portion distant from the lower surface on the side of the thermally functional layer (L) by 45 mm, and bringing a flame of the Bunsen burner having a height of 55 mm from the flame port into contact with the lower surface of the thermally functional layer (L) for 30 seconds while preventing the flame from being in contact with an end portion of the flame-retardant polymer member, the flame-retardant polymer member has flame retardancy capable of blocking the flame.

4. A thermally functional flame-retardant polymer member according to claim 1, wherein the thermally functional layer (L) comprises a heat-shielding layer (L).

5. A thermally functional flame-retardant polymer member according to claim 4, wherein the heat-shielding layer (L) contains at least one kind selected from a pigment, a ceramic, a metal, and a micro balloon.

6. A thermally functional flame-retardant polymer member according to claim 4, wherein the heat-shielding layer (L) comprises at least one kind selected from an applied layer, a sheet layer, a foil layer, a sputtered layer, and a deposited layer.

7. A thermally functional flame-retardant polymer member according to claim 1, wherein the thermally functional layer (L) comprises a heat-conductive layer (L).

8. A thermally functional flame-retardant polymer member according to claim 7, wherein the heat-conductive layer (L) contains a heat-conductive substance.

9. A thermally functional flame-retardant polymer member according to claim 8, wherein the heat-conductive substance comprises at least one kind selected from an inorganic oxide, an inorganic nitride, and a carbon compound.

10. A thermally functional flame-retardant polymer member according to claim 1, wherein the thermally functional layer (L) comprises a heat-insulating layer (L).

11. A thermally functional flame-retardant polymer member according to claim 10, wherein the heat-insulating layer (L) contains hollow bead structures.

12. A thermally functional flame-retardant polymer member according to claim 11, wherein the hollow bead structures comprise glass beads.
